(19) United States
(12) Patent Application Publication
(10) Pub. No.: US 2006/0123465 A1
(43) Pub. Date: Jun. 8, 2006

(54) Method and system of authentication on an open network

(76) Inventor: Robert Ziegler, Dallas, TX (US)

Correspondence Address: HOWISON & ARNOTT, L.L.P, P.O. BOX 741715, DALLAS, TX, 75374-1715, US

(21) Appl. No.: 11/241,870

(22) Filed: Oct. 1, 2005

Related U.S. Application Data
(60) Provisional application No. 60/615,530, filed on Oct. 1, 2004.

(51) Int. Cl. H04L 9/32

(52) U.S. Cl. 726/2

(57) ABSTRACT

A system for authentication over an open network includes at least a first endpoint on the open network and a second endpoint on the open network that require authentication of a transaction therebetween. A transaction authority communicates with the first endpoint and the second endpoint via the open network. An ATM network is accessible by the authentication authority for authenticating the first and the second endpoint within the ATM network. A biometric network is accessible by the authentication authority for authenticating the first and the second endpoint within the biometric network. The transaction authority extends the authorization capabilities of the ATM network to the first and the second endpoints via the open network to provide authentication of the first and the second endpoints and also extends the authorization capabilities of the biometric network to the first and the second endpoints via the open network to provide authentication of the first and the second endpoints.

### CROSS-REFERENCE

This application claims benefit of U.S. Provisional application Ser. No. 60/615,530, filed on Oct. 1, 2004 and is related to U.S. patent application Ser. No. ______ (Atty, Docket No. PAYT-27,346) entitled “System and Method for Electronic Check Verification Over a Network,” filed Oct. 1, 2005 which is incorporated herein by reference.

### TECHNICAL FIELD OF THE INVENTION

This invention is related to a security protocol, particularly an authentication protocol for use over a network.

### BACKGROUND OF THE INVENTION

In any financial transaction, it may be important that the identity of both parties be authenticated in a manner which positively establishes the identities of the parties. It may also be important that the transaction be non-reputable, so that neither party can deny their involvement in the transaction at a later date. Traditionally, the authentication of transactions were established principally by face-to-face meetings and handwritten signatures. People could identify each other and experts could attest to the authenticity of handwriting. Authentication was not impervious to fraud, but was strong enough to provide reasonable levels of transactional security.

As more and more of the economy has embraced networked transactions, traditional methods of authentication have become unworkable. The digital signals that transverse a network cannot be traced back to their source and can easily be forged or fudged. At the same time, the volume of network transactions has risen inexorably, with trillions of dollars being transferred digitally.

The Internet is a massive data pipe, transmitting information to and from endpoints utilizing low and high level protocols manipulated by applications running in secure and insecure operating systems on general purpose computers. Securing of communications, operations and endpoints over the Internet comprises a point of great interest to a number of entities.

The consumers participating in a value chain are subject to a perception of trust that their SSL session with a merchant or processor or both in a tri-party conversation provides adequate authentication of the parties involved in the transaction and secures the conversation from accidental or direct listening that could subvert the perceived trust, lead to loss of data, or still worse lead to the theft of private or secret information. The level of trust enables the merchant to certainly deliver data and protect information about the participants from identify theft, monetary gain or disclosures that may ruin the reputation of one or all of the participants.

In the corporate world systems that may use software or hardware to secure a conversation between two endpoints, such as two offices located at opposite parts of the US (CA, Mass) that might employ a virtual private network utilizing hardware that is enabled with certificates that are used during session negotiation to assert identify for authentication and establish a working key that is exchanged under a PKI session. However the users of that secure pipe are at risk from internal threats and downstream threats as exposed by the target endpoint since the service or data repository sought is not within the VPN.

Industries responsible for securing the endpoints developed a series of technologies that require both participants to possess some shared knowledge and at a minimum agree on a protocol or utilize a corresponding application that understands the dialog to an originating endpoint, such as RSA secure token or CISCO software VPN. A software VPN is established by virtue of a known software client that accepts a password or pin and may install a certificate that is presented using the PIN/password as a cryptographic mechanism in the authentication process. The receiver may first be a hardware VPN to establish a secure and authenticated transaction to all the originating endpoints to access resources within the corporation, or services if said endpoint is itself an application. In the matter regarding the RSA token, the token utilizes dynamic passwords combined with the certificate and user ID to segregate the authentication of the endpoint from the authorization to access resources, inherently authenticating and securing the originators connectivity and their identity to access same resources or services.

In the context of a network, transactions involving payments on the Internet only require SSL which utilizes a pre-installed non-specific authorization (no relationship to computer or consumer identity) to negotiate with a registered certificate held by a processor or merchant. The consumer must trust the connection as no active verification of the certificate is performed to assert the authenticity of the endpoint and/or consumer. Since the originator has a non-specific certificate the originator can not be authenticated by downstream participants. These limitations of the existing open network environment create risk for transacting financial, commerce and other types of transactions wherein the liability to one or more parties may arise from the transactional activity between the parties or information may be lost-to hackers, thieves, etc.

In evaluating the cost of authentication and securing the open network, several factors impact consumer and provider decisions. Thus for example, the cost of deployment, and the skills required for installation by the consumer for implementation of an authorization system. As a result, the sellers of goods and services over an open network have undertaken/underwritten the risk by conducting business without being afforded the protections of authentication, verification and secure dialog. Consortiums like Liberty Alliance attempt to rally a ubiquitous solution based on protocols and methodologies to establish universal credentials for authentication and verification to establish a federate authentication scheme that can be used to secure conversations and authenticate payment and other transactions including making those transactions non-reputable.

The evolutions of ATM/POS debit networks over the last 20+ years ago have maintained a ubiquitous, federated authentication system based on a debit card number and a PIN. The PIN is establish utilizing out-of-band, secure physical delivery and verification of the consumer during creation of the PIN. Since the consumers identity is required by law to be on file with the issuing institution. The pin is recognized as the identity of the consumer and is recognized as an electronic signature by Reg E, E-Sign and Verisign. The requirements on the financial institutions have been strengthened worldwide due to wire fraud, terrorism and related matters that benefit from a non-authenticated verified identify scheme. The PIN as a method of identification and authenticating of a token has been significantly enhanced as the underlying credentials associated visa-vie the DDA/Debit card relationship.

What is therefore needed is an authentication system and method suitable for authenticating network transactions on a open network.

### SUMMARY OF THE INVENTION

The present invention disclosed and claimed herein, in one aspect thereof, comprises system for authentication over an open network includes at least a first endpoint on the open network and a second endpoint on the open network that require authentication of a transaction therebetween. A transaction authority communicates with the first endpoint and the second endpoint via the open network. An ATM network is accessible by the authentication authority for authenticating the first and the second endpoint within the open network. A biometric network is accessible by the authentication authority for authenticating the first and the second endpoint within the biometric network. The transaction authority extends the authorization capabilities of the ATM network to the first and the second endpoints via the open network to provide authentication of the first and the second endpoints and also extends the authorization capabilities of the biometric network to the first and the second endpoints via the open network to provide authentication of the first and the second endpoints and authentication of the identity of a user associated with the first and the second endpoints.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a secure PIN processing system;

FIGS. 2A and 2B illustrate a communication flow chart of a secure PIN processing system;

FIGS. 3A-D illustrates a flowchart of a secure PIN processing system process;

FIG. 4 illustrates an functional block diagram of an authentication system; and

FIGS. 5A-B illustrates a communication flow chart of an authentication process.

FIG. 6 illustrates an authentication system;

FIG. 7 illustrates an authentication process;

FIG. 8 illustrates a capture process;

FIG. 9 illustrates an authentication process;

FIG. 10 illustrates a transaction process;

FIG. 11 illustrates an initialization process;

FIG. 12 illustrates a biometric authorization process;

FIG. 13 illustrates a PIN capture process;

FIG. 14 illustrates a PIN capture process;

FIG. 15 illustrates a PIN capture process;

FIG. 16 illustrates an authentication system;

FIG. 17 illustrates a capture process;

FIG. 18 illustrates a capture process;

FIG. 19 illustrates a PIN generation process;

FIG. 20 illustrates an authentication process;

FIG. 21 illustrates an initialization process;

FIG. 22 illustrates a PIN capture process;

FIG. 23 illustrates a transaction process;

FIG. 24 illustrates a PIN block generation process;

FIG. 25 illustrates an authentication process; and

FIG. 26 illustrates an authentication system;

FIG. 27 is a full diagram illustrating the process for generating and transmitting imprint;

FIG. 27B illustrates the process for generation of an imprint;

FIG. 27C illustrates the process for transmission of an imprint;

FIG. 28 illustrates one manner in which an ATM may be used to transmit dedicated cash and services;

FIG. 28A illustrates the manner of which ATM may be used to transmit cash and services over the Internet;

FIG. 29 is a full diagram illustrating manner, a customer may use system of the present invention to obtain downloadable content;

FIG. 30 illustrates the establishment of signing keys;

FIG. 31 illustrates the distribution of software and the system;

FIG. 32 illustrates a transaction initiation;

FIG. 33 illustrates the authentication process;

FIG. 34 illustrates the geo location process;

FIG. 35 illustrates the manner of which both biometric and ATM network may be used for authentication.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

With the above described problems, what is needed is an authentication system and method suitable for authenticating network transactions over a point to point connection over a network such as the Internet.

In on embodiment for achieving authorization over an open network, the process employed by biometric companies may be utilized wherein the registration process requires proof-of-identity at the time a parties biometric signature is captured. This is an equivalent process to establishing an authenticated identity and to expressing that identity in a number of modalities. The biometric process establishes a PIN, password, or pseudo search code (PSC) which could also be a debit card/pin or some credential process. This insures that a parties secret isn't easily obtained (like a PIN number for your ATM card). Then the identity as authenticated and related to the biometric data can be considered immutable, protected data and not at risk of theft by unauthorized parties without the express permission of the consumer (outside a forcible act against the consumer causing them surrendering their PIN and biometric at a specific point in time). This is similar to the risk in a ATM network wherein a cardholder may be forced at gun point to surrender their card and PIN to allow a thief to steal with their identity.

Secure data provision of the PIN and associated data can be provided in a number of ways. One manner for providing security involves an enrollment process where access to that data is controlled via a secure authentication process that can establish the same level of trust for the biometric process making it PIN compatible.

Software at an endpoint on the open network may also provide authentication of the endpoint and of upstream and downstream endpoints. If it is determined that software for performing the authentication is not available at the endpoint, the software must be delivered. The delivery of Software on the originating endpoint is enabled wherein each piece of software on every general purpose computer is globally unique and carries verifiable qualities to differentiate it from other software delivered to other devices at other endpoints. The software can be retired, updated, effectively managed in a way to prevent known devices from presenting transactions for undesirable purposes, such as denial attacks, QOS attacks, etc.

General purpose computers (GPC), PDAs or cell phones may have a built-in ID's, the downloaded software can generate a globally unique ID for the GPC which may combine elements of one or more device or system characteristic to establish a globally unique ID for the server-computer terminal.

The other endpoints have corresponding software or components provided by the transaction authority that allow them to authenticate up and downstream endpoints so that they can authenticate the participants and secure the conversation.

Location of an entity may also be used as a basis of authentication. The location of the consumer from their-registration and/or payment details is processed to form a full-qualified and verifiable physical address which is then processed into geographic location data, for example, physical longitude/latitude. The endpoints can trace a transaction from an endpoint to another endpoint and acquire details about each IP enabled device in the conversation and narrow the location of the virtual terminal into a longitude/latitude that can be compared to the physical world longitude/latitude. Thus, a terminal, device, GPC, or software IP address can be tracked and evaluated for risk. For example, does the route path take it through an off limit domain like Iraq or does the device between the endpoints on the second hop take excessive processing time and change header information acting as a anonymous-zing gateway. A trusted 3^{rd} party transaction inspects all these details and acts an authorizing entity for the two participating endpoints to secure the communication pathway and verify the participating devices, GPC, etc., moving the authentication from the VPN device context and securing the communications to the authenticated endpoints.

Now that the communications are secure and the devices authenticated, the transaction processor orchestrates the secure processing of a transaction request. The initiator of the transaction being the consumers software component which may include a dynamically downloaded/injected component (that is robustly secure and verified, and signed) that is designed for single-use, a single transaction, or for a single communication session, such as instant messaging, or may be just a browser session interacting with the secure component, extending the utility value of the software terminal.

Once the participants have been authenticated and the communications secured, the software within an endpoint will acquire as directed by the transaction processor or the dynamically injected code capture of anything that can be accepted via mouse, keyboard or any other device such as card reader, biometric reader, etc in a manner that insures the data's secrecy is maintained.

The system may request the consumer to verify identity and authenticate themselves prior to accepting any financial or other transaction, or may be simply a step associated with activating their online banking session. In that context, the software may prompt for a debit card, or the transaction processor by virtue of authenticating the terminal or by virtue of capturing a biometric data identifying the individual will have access to information available in a secure data store. The software would then require the PIN to be selected using the graphical process described here in below. Upon successful verification by the ATM/Debit network, transmit proxy, financial institution, third party and/or the issuer the consumer's identity (or other authentication requirement) and affinity have been authenticated and that authenticated party can be used for any type of financial or other transaction that recognize e-sign law or as an electronic signature under REG E, the transaction may be carried out.

In the simplest form without the PIN, this system secures and authenticates the end-points engaged in the transaction using the transaction processor as the authenticator.

In the ideal form the PIN combined with biometrics forms a ubiquitous Level 4 authentication scheme, combining both biometric and debit card/pin, to provide non-reputable identity authentication necessary for voter registration, online-gaming (legalized jurisdictions), lottery, online voting.

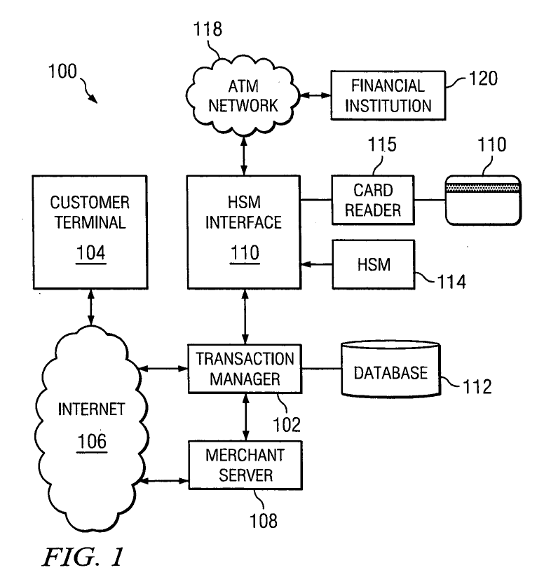

With reference to FIG. 1, a secure PIN processing system 100 is shown. In accordance with the preferred embodiment, the secure PIN processing system 100 serves as a part of an on-line commercial transaction process. It should be understood that the secure PIN processing system 100 may be used in other network transaction environments, typically in processes where a party must be authenticated without the insecure transfer of authenticating data. A personal identification number (PIN) is a sequence of numerals, where the number of digits creates a sufficiently high probability that a person in possession of the PIN can be positively identified as a specified person. PIN are most commonly used in association with bank debit cards. Bank debits cards are used at automated teller machines (ATM) connected to the ATM Network. An ATM network may also comprise any network providing the same services as an automated teller machines (ATM) network even if the network is provide by a financial institution or other entity. When the customer presents the card to the ATM, the ATM prompts the customer to enter a PIN. The customer enters the PIN into the ATM. The ATM processes the PIN and data read from the bank debit card to identify the customer presenting the card as the legitimate owner of the card. The process for PIN-based transactions with debit cards at ATM is heavily regulated.

For purposes of the disclosure, a PIN may be any sequence of numbers used to identify, particularly where the identification is part of a transaction. Inasmuch as the ATM Network has specific requirements, the preferred embodiment is tailored to that use. It will be apparent to those having skill in the art that the same protocols can be used in a wide variety of situations, particularly situations where identification is part of a network transaction. Debit cards are only one example of tokens that may be associated with a PIN. Credit cards, identification cards, keyfobs, cellular telephones, personal digital assistants, computers, portable computers and computing devices, smart cards and passive or active transmitters are examples of types of tokens that may be identified with a holder by a PIN. Serial numbers, passwords, biometrics, identification numbers, registration numbers, student identification numbers, network passwords, including numerals, characters or any graphic symbol, are examples of sequences that may act as a PIN.

In the on-line commercial transaction process, a customer using a customer terminal 104 is connected to an open network 106 such as the Internet. The customer terminal 104 is preferably a personal computer at use in a home or office. It should be understood that the customer terminal 104 may be any digital device that can be communicably connected to an open network 106 and is capable of receiving data input by the customer and processing the data input by the customer before transmission to the open network 106.

Typically, the customer at the customer terminal 104 is connected to a merchant server 108 via the Internet 106. The merchant server 108 may offer goods or services for sale to the customer, with one or more web pages serving as consumer interfaces. When the customer has made appropriate selections at the merchant web site, payment options are typically given to the customer. Communication between the customer terminal 104 and the merchant server 108 will typically be conducted using a secure socket layer (SSL) connection, although the security of the transaction communication may be in accordance with another protocol or even made in the clear, depending on the security needs dictated by the specific transactions and protocols. In accordance with the present embodiment, when a debit-type transaction where money is transferred from a customer bank account at a financial institution 120 via the ATM network 118 is selected, the transaction is initiated, typically by a transaction initiation message sent from the customer terminal 104 through the open network 106 to the merchant server 108.

When a transaction initiation message is received at the merchant server 108, the merchant server 108 communicates the transaction initiation, including transaction details, merchant details and customer details, to the transaction manager 102. Communications between the merchant server 108 and the transaction manager 102 are typically conducted using a dedicated communication network or a virtual private network (VPN). Some communications between the merchant server 108 and the transaction manager 102 may be conducted via the open network 106, but because of the confidential nature of the financial transaction, communication between the merchant server 108 and the transaction manager 102 will typically use a secured connection.

The merchant server 108 will establish a connection between the customer terminal 104 and the transaction manager 102. This connection will typically be established in such a way that the customer at customer terminal 104 is generally unaware that the customer is communicating with the transaction manager 102 instead of the merchant server. However, once the connection is established between the customer terminal 104 and the transaction manager 102, the merchant server 108 is privy to none of the data exchanged between the customer terminal 104 and the transaction manager 102. This protocol prevents the merchant server 108 from intercepting the communications between the customer terminal 104 and the transaction manager 102 and gaining access to confidential financial or personal data, as well as preventing man-in-the-middle attacks on the system.

The transaction manager 102 is communicably connected to a transaction manager database 112. The transaction manager database 112 stores algorithms and other data used in the transactions. When the customer terminal 104 initiates a first transaction, the transaction manager 102 retrieves a copy of a transaction module from the transaction manager database 112 and sends a transaction module to the customer terminal 104. The transaction module secures the customer terminal 104 and regulates the transaction process at the customer terminal 104. The transaction manager database 112 may store algorithms used to generate a dynamic PIN input interface, encryption algorithms, components of encryption algorithms and other data used as unshared secrets. The algorithms and data stored in the transaction manager database may be organized in families, such that when a family is selected by a transaction module, the processing steps may be chosen by identifying portions of the family and with data to determine the variables used in the creation of corollary data.

The transaction manager 102 is communicably connected to a Hardware Security Module (HSM) interface 110. The HSM interface 110 may be a secure configuration terminal (SCT). The connection between the transaction manager 102 and the HSM interface 110 is typically a secured line connection. The HSM interface 110 is connected directly to an HSM 114. The HSM 114 or the HSM interface 110 may include an card reader 115 for reading data from a key card 116.

The location of the consumer from their registration and/or payment details is processed to form a full-qualified and verifiable physical address which is then processed into longitude/latitude or other types of geographically identifying data establishing a location.

The endpoints can trace the call from either endpoint to the other and acquire details about each IP enabled device in the conversation and narrow the location of the virtual terminal into a longitude/latitude that can be compared to the physical world longitude/latitude. Thus, terminal, device, GPC, software IP appearance can be tracked and evaluated for risk. For example, does the route path take it through an off limit domain like Iraq or does the device between the endpoints on the second hop take excessive processing time and change header information acting as a anonymous-zing gateway.

In accordance with the preferred embodiment, the Hardware Security Module 114 is a programmable or intelligent HSM. A programmable HSM is, generally, an HSM that is capable of interpreting injected data as programmatic instructions. Programmatic instructions may refer to executable images like an application written in a programming language such as assembly code, C or C++. Runtime images like a JAVA application may be used as programmatic instructions.

By programming the intelligent HSM, the HSM may implement programmed behavior either statically or dynamically. In this way, the HSM may be programmed to securely interact with the cryptography functions of the HSM. Applications may be downloaded into the HSM using any secure methodology. For example, the applications may be input into the HSM using a serial port, a network adaptor, smart cards, floppy disks, cd-roms, an infrared port or any other known input mechanism. In accordance with the preferred embodiment, a smart card 116 may be used to inject algorithms, keys or other secure data into the HSM 114.

The executable code injected into the HSM 114 is typically authenticated using a digital signature of the executable code generated by an authorized publisher. Other authentication methods may be used. The executable image, when executed, is programmed so that data is exchanged between the HSM 114, the HSM interface 110 and other connected systems in a secure manner. In particular, the programming prevents compromise of the HSM 114 including the algorithms and keys stored therein. The HSM 114, in accordance with the preferred embodiment, is capable of both reading and writing to smart card 116.

The HSM 114 is, in accordance with the preferred embodiment, a Tamper Resistant Security Module (TRSM), preventing physical as well as logical intrusion. Using approved software components, a customized secure configuration terminal (SCT), ACL definitions, policies and procedures, the programmable HSM 114 can be made to meet X9 key management requirements. In particular, the HSM 114 can perform X9 compliant key exchange keys, split knowledge key management, dual control, key fiagments, key pair generation, key injection, key combining, key exchange, key loading, key recovery, destruction of keying material, key management with encrypted keys, PIN block creation, PIN block translation, PIN management with encrypted PIN. The HSM 114 may be an X9 compliant tamper proof enclosure with key destruction when the enclosure of the HSM has been compromised. Policies and procedures for these processes are made auditable and verifiable.

The HSM 114 may be encased in a durable, tamper-resistant casing to protect the system against intrusion, with built-in detection features capable of sensing sophisticated attempts at physical or electronic tampering. An unauthorized attempt to access the HSM results in the immediate and automatic erasure of the secured algorithms and data stored in the HSM 114. The HSM 114 is a TRSM capable of enforcing key confidentiality and separation. The HSM 114 allows dual control, tamper detection and active countermeasures such as automatic key erasure upon compromise. These types of devices and environmental security measures currently exist in many systems of financial institutions, network processing centers and military installations.

The HSM 114 may also use access control lists to allow fine-grained control over key separation, key injection and key management. The HSM 114 will preferably be programmed so that it will only accept authenticated trusted code provided by an authenticated trusted publisher. Authentication of the trusted code and trusted publisher is typically achieved using an appropriate digital signature authentication protocol.

The HSM 114 may be programmed to refuse to load trusted code during key loading processes. The HSM 114 may be programmed to restrict code loading in accordance with X9 audit procedures. The HSM 114 should pass FIPS-140 validation requirements. The HSM 114, in conjunction with an SCT and approved key management practices allow for the management of keys for injection into devices that are physically or geographically separate, as may be required for business continuance best practices. The HSM 114, in conjunction with an SCT, can meet or exceed all key management practices required by the X9 TG-3 audit guidelines or associated standards.

To make the HSM 114 compliant with X9 requirements, the programmed HSM 114 requires that private keys and symmetric keys exist in an acceptable secure format. The keys may be rendered as clear text inside the protected memory of a tamper resistant security module, or encrypted when rendered outside of the protected memory of a tamper resistant security module. The keys may be rendered as two or more key fragments or key components either in clear or ciphertext and managed using dual control with split knowledge fragmentation of the keys. Secret-sharing enables the key fragments to be stored separately on tokens so that less than all of the key fragments (k-of-n key fragments) are required to load or reconstitute the key being protected. Good security practice requires key separation, whereby each key or key pair is generated for a particular purpose and used solely for the purpose for which it was intended.

The HSM interface 110 may be interfaced directly or indirectly with the HSM 114 for loading the key-encryption-key (KEK), key pairs as well as any other activity necessary to meet X9 standards for key management. Accordingly, the HSM interface 110 may be connected directly to the HSM 114, for example using an SCSI, IDE, serial port, parallel port, USB port, keyboard, mouse, or firewire port. The HSM interface 110 may be connected indirectly to the HSM 114, for example using an infra-red port. The HSM interface 110 may be interoperable with the HSM 114 via use of smart cards with supporting processes and procedures to insure key management policies and procedures can be implemented. Future connection methodologies that comport with the required standards may also be used.

The HSM interface 110 may be encased inn a durable, tamper-resistant casing to safeguard the system against incursion. The HSM interface 110 should also include built-in detection techniques capable of sensing sophisticated attempts at physical or electronic tampering. These techniques may provide for immediate and automatic erasure of secured algorithms and data stored in the device.

In accordance with one embodiment, the HSM interface 110 may provide graphics display, allowing it to support a variety of graphic character sets, including Japanese, Chinese, Arabic and Cyrillic-based languages. The display may be configured to show two lines of Chinese prompts, two lines of large characters or up to four lines of Roman text. The HSM interface 110 may be capable of displaying two languages simultaneously, such as French and English, for use in multi-lingual environments.

The HSM interface 110 may be configured to support custom application development and remote downloading of an executable image. The download process will typically require a trusted code source and use executable code that is authenticated, through a digital certificate, hash, MAC or other methodology sufficient to prove the authenticity and integrity of the executable code.

The HSM interface 110 may provide access control using smart cards, token devices, passwords or other methodology. Access control is used to insure that code downloads can only be accomplished by authorized trusted entities. Use of the HSM interface 110 may be restricted using access control. Key loading is restricted to authorized parties using access control. Key injection is restricted to authorized parties using access control. Software download is restricted to proprietary protocols and otherwise restricted using access control.

The HSM interface 110 insures that access to any keying information entered can not be controlled or denied to one or all users of the HSM 114. The HSM interface 110 may provide an interface for the HSM 114. The HSM interface 110 may provide simultaneous support for multiple key management functions. The HSM interface 110 may provide comprehensive software security and tamper-proof casing. The HSM interface 110 may store keys securely in a security chip. The HSM interface 110 may include the ability to wipe keys from the security chip upon completion of keying activity if required. The HSM interface 110 may provide secure communications between a keyboard, a display and a security module. The HSM interface 110 may provide a PIN pad that supports alpha-numeric entry. The HSM interface 110 may provide a smart card reader and writer supporting a plurality of asynchronous and synchronous memory and protected-memory cards. The HSM interface 110 may include a magnetic strip reader that can read and write Track 1 and 2 or Track 2 and 3. The HSM interface 110 may provide a serial interface.

The HSM interface 110 smart and magnetic card reader 115 may provide a secure and verifiable erasure feature to insure no residual keying material exists after keys have been injected or keying material has been discarded. This may be implemented as a procedure that requires erasure of the material be performed and verified to substantive level. The card reader and writer 115 may support both EMV for smart card support, debit cards, credit cards, and ATM cards. The HSM interface 110 may be both physically and electronically secure, and may contain an integral security module, with an encryption chip, that offers simultaneous support for encryption and key management functions. The security module may be provided to work with DES, Triple DES, RSA encryption ECC, AEC, and supports Master/Session Key, DUKPT (derived unique key per transaction) and regional key management methods.

The HSM interface 110 may provide additional features that are not required to secure the HSM 114, as the device may include higher order utility capabilities for acting as a PIN pad in online and offline debit transactions.

The HSM interface 110 is communicably connected, typically by a secure line connection, to a closed network 118 such as the ATM Network. This closed network 118 provides communication to one or more financial institutions 120. Transaction for the transfer of monies from one account to another is performed by communications transmitted through the ATM Network 118.

In typical prior art systems, using software-based cryptography, all of the cryptographic components (i.e., algorithm, key, clear, ciphertext) reside in unprotected memory, where they are susceptible to duplication, modification, or substitution. The most susceptible element is the cryptographic key. A duplicated key allows an attacker to recover all encrypted data. In addition a duplicated asymmetric private key allows an adversary to falsely generate digital signatures that would be attributed to the computer owner. A substituted or modified public key would allow a “man-in-the-middle” attack such that the adversary could intercept and change e-mails or transaction data undetectable by the sender or receiver.

In the hardware-based cryptography, physical and logical barriers limit data access, while the algorithm and key are kept secure in the protected memory of the HSM 114. Thus, hardware based cryptography ensures the confidentiality, integrity, and authenticity of cryptographic keys and, further, provides assurance regarding the integrity and authenticity of the cryptographic algorithm, which reinforces the overall level of security.

The secure PIN processing system 100 insures that the key management policies, practices and lifecycle controls which deal with an organization's policies and practices regarding the management of private asymmetric keys, symmetric keys, and other types of keying material (e.g., pseudo-random number generator seed values), including cryptographic hardware management. Key management life cycle control information should be disclosed to allow relying parties to assess whether the organization maintains sufficient controls to meet its business requirements and insure key generation practices, such that cryptographic keys are generated in accordance with industry standards.

The secure PIN processing system 100 manages the random or pseudo-random number generation process, prime number generation, key generation algorithms, hardware and software components. The secure PIN processing system maintains adherence to all relevant standards as well as references to the key generation procedural documentation including key storage and backup. Asymmetric private keys and symmetric keys remain secret and their integrity, authenticity and recovery practices may be retained. The secure PIN processing system 100 allows the use of key separation mechanisms using hardware and software components. This permits provable adherence to all relevant standards and provides references to key storage, backup, and recovery procedures. The secure PIN processing system 100 controls the initial key distribution processes, subsequent key replacement processes, and key synchronization mechanisms.

The secure PIN processing system 100 relies on the HSM 114 not just for security by also to insure the cryptography which is CPU intensive is optimized for high scalability and is capable of supporting diverse applications. The secure PIN processing system and process 100 may dramatically increase the number of cryptographic keys generated, distributed, installed, used, and eventually terminated. This proliferation will stress the scalability of key management software and the key storage mechanisms that will be forced to manage more and more cryptographic keys.

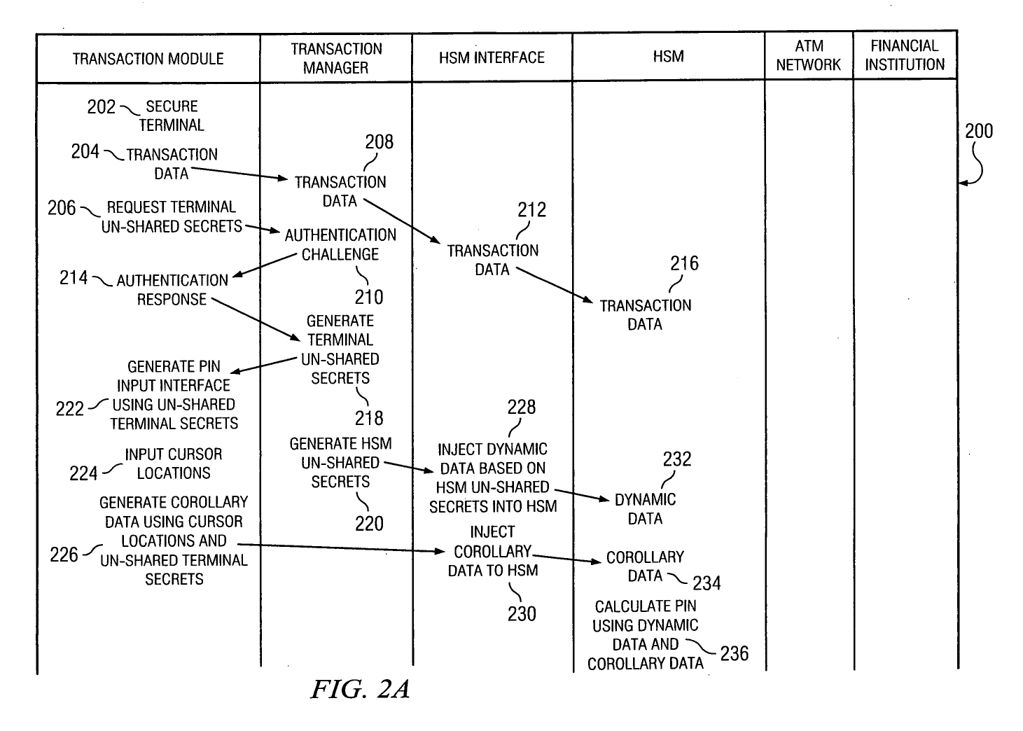

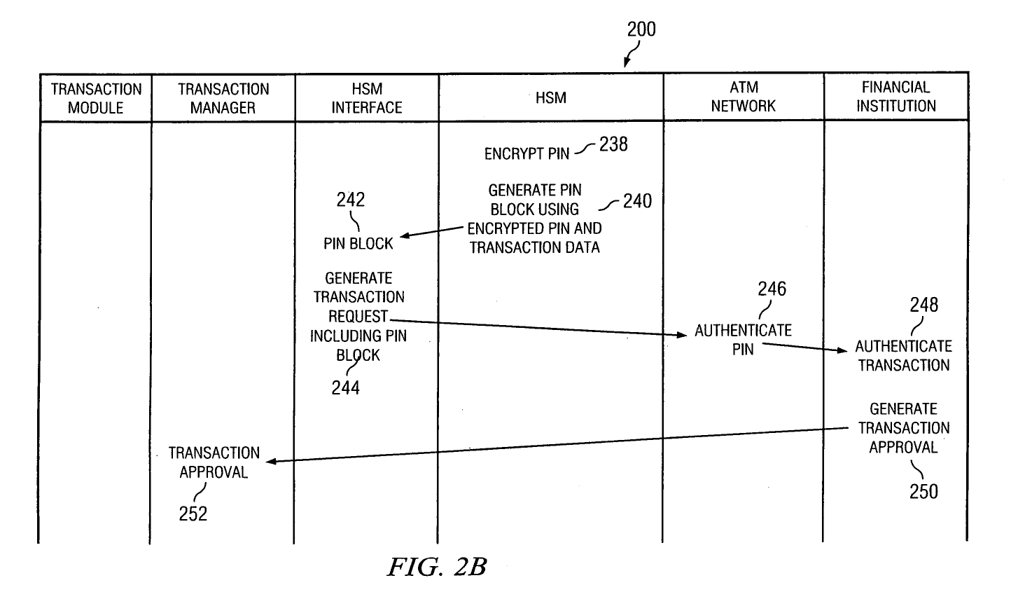

With reference to FIGS. 2A and 2B, a communication flow chart for the secure PIN process 200 is shown. When the transaction module is executed, the transaction module performs a procedure for securing the customer terminal 104 in step 202. The process for securing the customer terminal 104 may include checking the location, registry and memory of the customer terminal 104. The transaction module checks to see if there is any indication that the transaction process may be rendered insecure by the customer, customer software or customer hardware. A port scan is performed. The customer terminal 104 interrupts and vectors are checked. The transaction module searches for hardware crackers, memory tracers, etc. so that biometric verifications may be performed. The goal is to insure that the customer terminal 104 is a safe operation within tolerance of a generic computer running generic software. If the transaction module determines that the customer terminal 104 is for any reason insecure, the transaction process is terminated.

When the customer terminal is determined to be secure, the transaction module sends transaction data to the transaction manager 102 in step 204. Some or all of the transaction data may be sent by the transaction manager 102 to the HSM interface 110 in step 212. Some or all of the transaction data may also be sent by the HSM interface 110 to the HSM 114. The specific transaction data shared by the transaction module, transaction manager 102, HSM interface 110 and the HSM 114 depends on the particulars of the protocols underway.

The transaction module requests terminal unshared secrets from the transaction manager 102 in step 206. Typically, the transaction manager 102 sends an authentication challenge to the transaction module in step 210. An authentication response is sent by the transaction module to the transaction manager 102 in step 214. The interchange of authenticating data may be performed in a variety of ways. The authentication may be bidirectional, such that the transaction module is authenticated to the transaction manager 102 and the transaction manager 102 is authenticated to the transaction module. The authentication may take place at other times during the process, and may be repeated in some protocols. Because the identity of the participants are especially important in a financial transaction, a wide variety of authentication protocols and procedures may be implemented to accomplish that goal.

The transaction manager 102 generates terminal unshared secrets in step 218 and HSM unshared secrets in step 220. The terminal unshared secrets are used to allow the transaction module to properly form and encode corollary data used to identify the PIN of the customer. The HSM unshared secrets are used by the HSM 114 to convert the corollary data into the customer PIN. The unshared secrets may include algorithms, portions of algorithms, families of algorithms, identifiers for selecting algorithms, portions of algorithms or families of algorithms. The unshared secrets may include data to modify the algorithms. Variables may be established by the unshared secrets.

The transaction manager 102 sends the terminal unshared secrets to the transaction module and send the HSM unshared secrets to the HSM 114. The transaction module generates a graphical PIN input interface for display on the customer terminal 104 using the unshared terminal secrets in step 222. The customer selects displayed portions of the graphical PIN input interface using a mouse to generate cursor location data in step 224. In accordance with the preferred embodiment, the graphical PIN input interface includes a graphical display of a numeric keypad, such the customer selects a digit of the PIN by clicking a mouse button when the mouse cursor is over the appropriate numeral. With each entered digit, the displayed keypad may be scrambled, such that a given mouse cursor location may indicate a different numeral with each entered digit. The cursor location data for each digit of the PIN is recorded by the transaction module as a graphical imprint which will be more fully discussed herein below. The transaction module then generates corollary data using the cursor location data and the unshared terminal secrets in step 226. The corollary data is sent to the transaction manager 102 which further sends the corollary data to the HSM interface 110.

The HSM interface 110 injects dynamic data into the HSM 114 using the unshared HSM secrets in step 228. The HSM interface 110 injects the corollary data into the HSM 114 in step 230. The HSM 114, using the transaction data 216, the dynamic data 232 and the corollary data 234, calculates the customer PIN in step 236.

The HSM 114 distills and then encrypts the PIN in step 238. The HSM 114 generates a PIN block using the encrypted PIN and transaction data in step 240. The HSM 114 sends the PIN block to the HSM interface 110 in step 242. The HSM interface 110 generates a transaction request including the PIN block in step 244 and sends the transaction request to the ATM Network 118. The transmission of the request or other of the transmitted items may occur immediately upon creation, wait until a consumer request, or responsive to a third party request. The ATM Network 246 or the financial institution 120 authenticates the PIN in step 246. The financial institution 120 authenticates the transaction in step 248. The financial institution 120 then generates a transaction approval message in step 250 and sends the transaction approval message to the transaction manager 102 in step 252. The transaction manager 102 notifies the merchant server that the transaction has been processed.

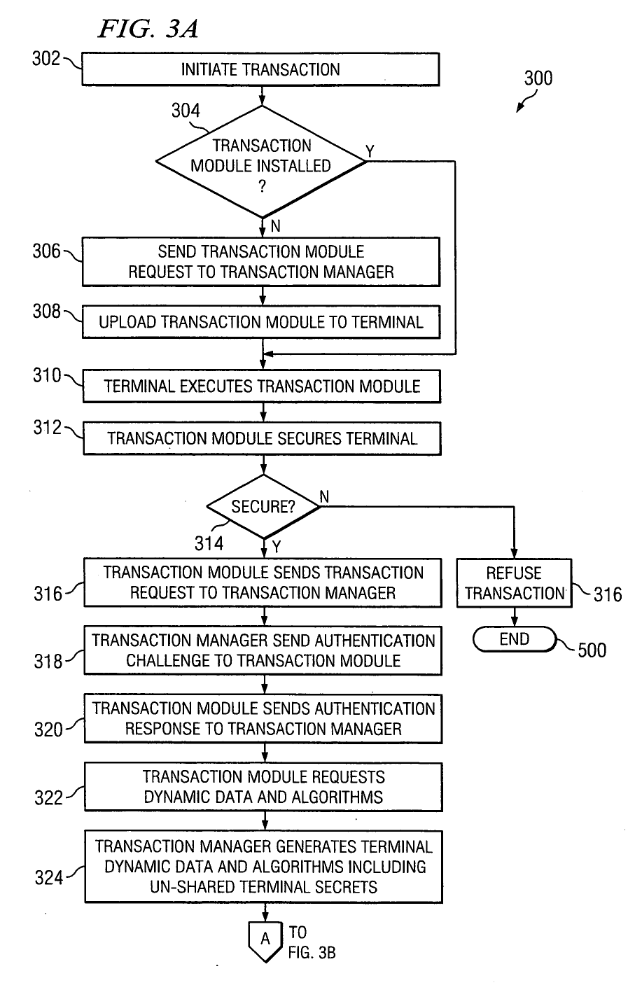

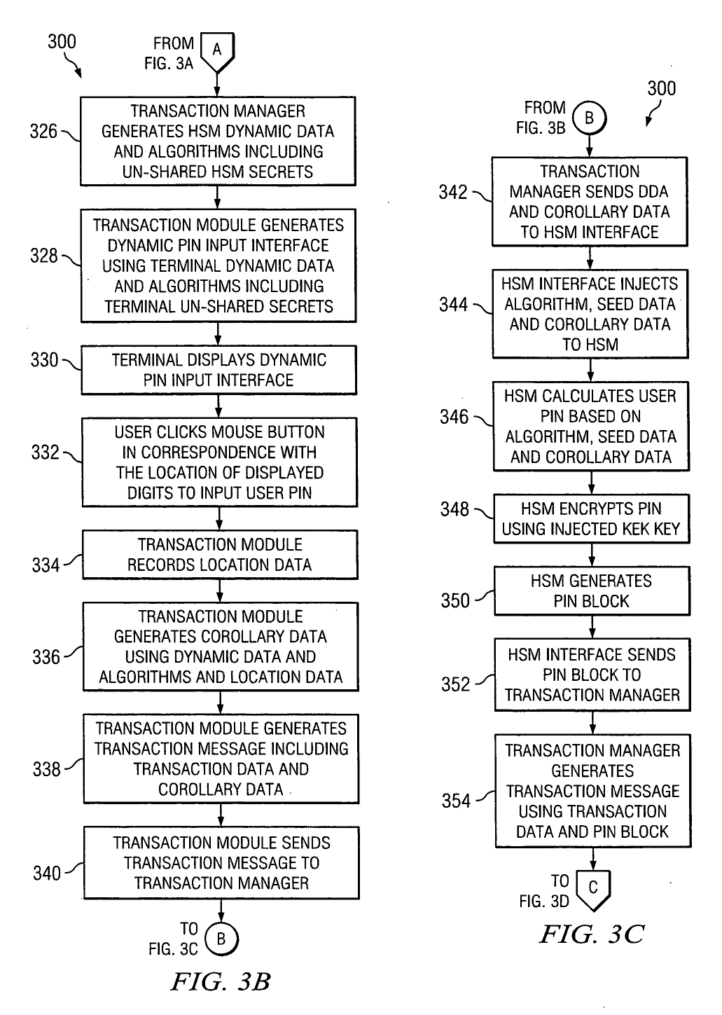

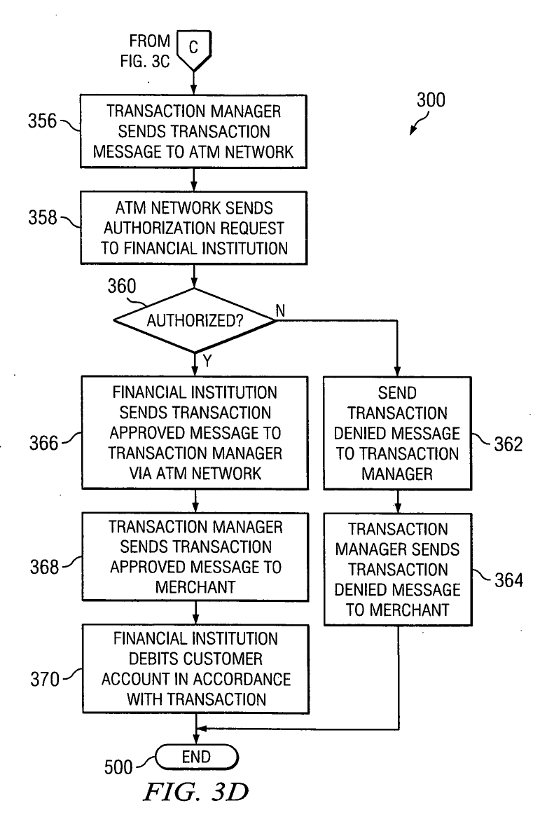

With reference to FIGS. 3A, 3B, 3C and 3D, a flowchart of the secure PIN processing process 300 is shown. The process begins as the transaction is initiated in function block 302. A check is done to determine if the transaction module has been installed at the customer terminal 104 at decision block 304. If a transaction module has not been installed, the process follows the NO path to function block 306, sending a transaction module request to the transaction manager 102. The transaction manager 102 retrieves the transaction module file from the transaction manager database 112 and uploads the transaction module to the customer terminal 104 at function block 308 and proceeds to function block 310.

If the transaction module was previously installed, the process follows the YES path to function block 310. At function block 310, the customer terminal 104 executes the transaction module. The transaction module then secures the customer terminal 104 at function block 312. A check is made to determine if the customer terminal 104 is secure at decision block 314. If the customer terminal is not secure, the process follows the NO path to function block 316 where the transaction is refused. The process then ends at block 500.

If the customer terminal is determined to be secure, the process follows the YES path to function block 316. The transaction module sends a transaction request to the transaction manager 102 at function block 316. The transaction manager 102 sends an authentication challenge to the transaction module at function block 318. The transaction module sends an authentication response to the transaction manager 102 at function block 320. If the authentication is not verified, the transaction is refused. The transaction module requests dynamic data and algorithms at function block 322. The transaction manager generates terminal dynamic data and algorithms including unshared terminal secrets at function block 324.

The transaction manager 102 generates HSM dynamic data and algorithms (DYDA) including unshared HSM secrets at function block 326. The transaction module generates a dynamic PIN input interface using terminal dynamic data and algorithms including unshared terminal secrets at function block 328. The customer terminal 104 displays the dynamic PIN input interface at function block 330. The user clicks the mouse button in correspondence to the location of a cursor over displayed digits in the dynamic PIN input interface in function block 332. The transaction module records the cursor location data at function block 334. The transaction module generates corollary data using the dynamic data and algorithms and the cursor location data at function block 336.

The transaction module generates a transaction message including transaction data and corollary data at function block 338. Proceeding to function block 340, the transaction module send the transaction message to the transaction manager 102. The transaction manager sends the dynamic data and algorithms and the corollary data to the HSM interface 110 at function block 342. The HSM interface 110 injects the HSM dynamic data and algorithms, seed data and corollary data to the HSM 114 at function block 344. Proceeding to function block 346, the HSM 114 distills the customer PIN, based on the algorithms, seed data and corollary data. The HSM 114 encrypts the PIN using an injected key-encryption-key at function block 348. The HSM 114 may encrypt the PIN using any of a variety of encryption techniques. In accordance with the preferred embodiment, the encryption is performed using a dual-controlled, split-knowledge key, which has been injected into the HSM 114 using a smart card 116. The HSM 114 then generates a PIN block using the encrypted PIN at function block 350.

The HSM interface 110 sends the generated PIN block to the transaction manager at function block 352. The transaction manager 102 generates a transaction message using the transaction data and the PIN block at function block 354. The transaction manager 102 then sends the transaction message to the ATM Network 118 at function block 356. The ATM Network 118 sends an authorization request to the Financial Institution 120 at function block 358.

At decision block 360, the financial institution 120 determines if the transaction is authorized. If the transaction is not authorized, the process follows the NO path to function block 362 where financial institution 120 sends a “transaction denied” message to the transaction manager 102. The transaction manager 102 sends a “transaction denied” message to the merchant server 108 at function block 364. The process ends at block 500.

If the transaction is authorized, the process follows the YES path to function block 366. The financial institution 120 sends a “transaction approved” message to the transaction manager at function block 366. The transaction manager 102 sends a “transaction approved” message to the merchant server 108. The transaction manager may wait for an authorization from the other endpoint. The financial institution 120 debits the customer's account in accordance with the transaction data at function block 370. The process ends at block 500.

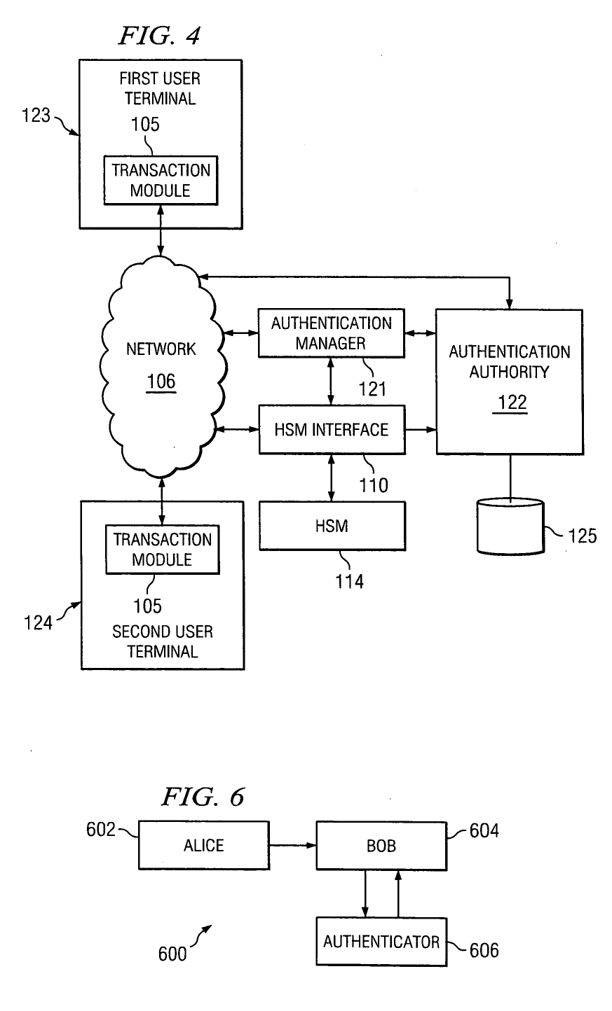

With reference to FIG. 4, a functional block diagram of an authentication system is shown. In accordance with the disclosed embodiment, a first user at a first user terminal 123 needs to be authenticated to a second user at a second user terminal 124. Similarly, the second user at the second user terminal 124 may need to be authenticated to a first user at a first user terminal 123, or the first and second users may need to be authenticated to each other.

The process assumes that each user trusts an authentication authority 122. The authentication authority 122 may maintain a secured database 125 associating PINs with user identification information, such that when the authentication authority 122 receives a message containing a PIN and user identification information, the authentication authority 122 may check the secured database 125 and authenticate the user identification information.

The first user terminal 123 includes a transaction module 105, as may the second user terminal 124. If only one of the users needs to be authenticated, only that user's terminal needs to have a transaction module 105. The user terminals, in particular the transaction module 105, are connected to a network 106. Typically, the network 106 is an open network such as the Internet, but an authentication system may be implemented on any communication network.

An authentication manager 121 may be connected to the network 121. The authentication manager 121 is in communication with an HSM interface 110, either directly or via the network 106. The authentication manager 121 may also be communicably connected to the authentication authority 122. The HSM interface 110 is in communication with an HSM, typically by a direct connection. The HSM Interface may also be connected to the authentication authority 122, either directly or via the network 106. The authentication authority may be connected to the network 106.

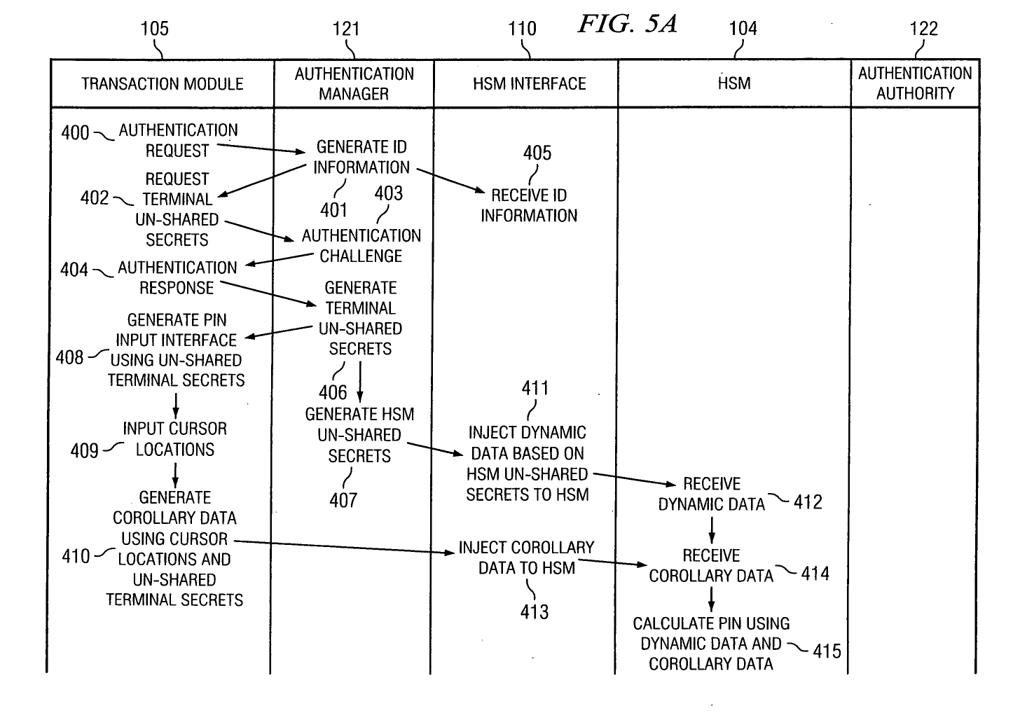

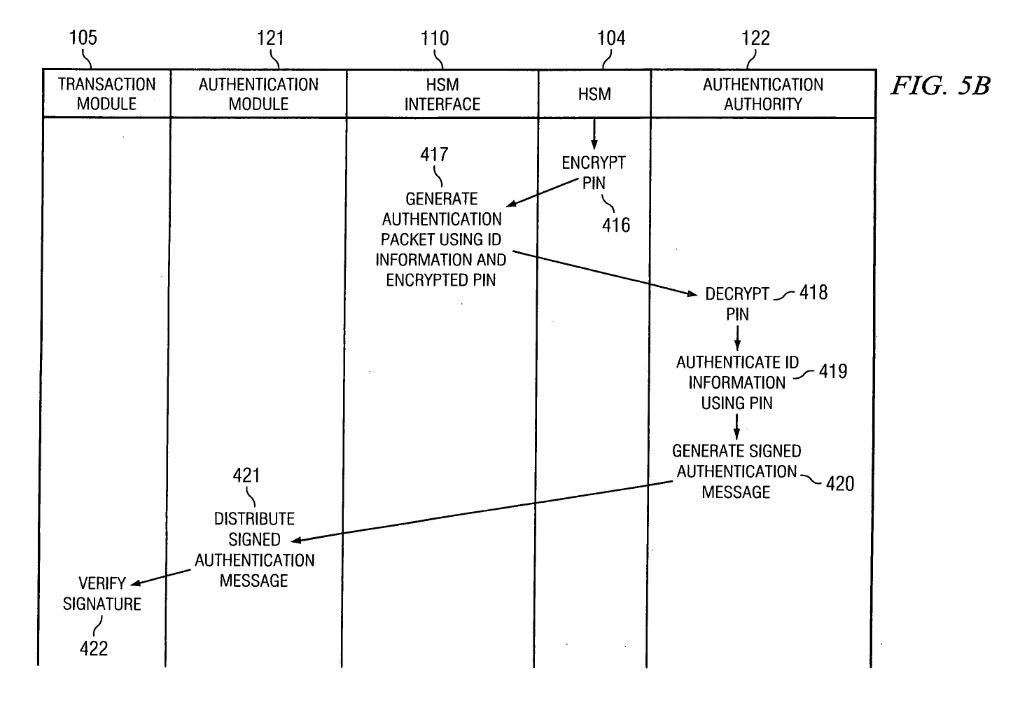

With reference to FIGS. 5A and 5B, a flow chart of an authentication process is shown. A transaction module 105 generates an authentication request which is communicated to the authentication manager 121 in step 401. The authentication manager 121 generates user identification information from the authentication request in step 401. The authentication manager 121 communicates the authentication request and user identification information to the HSM interface in step 405. The authentication manager 121 also sends an authentication acknowledgment to the transaction module 105. The transaction module 105 sends a request for terminal unshared secrets to the authentication manager 121 in step 402. The authentication manager 121 sends an authentication challenge to the transaction module in step 403. The transaction module 105 replies with an authentication response in step 404.

When the authentication response is received and verified by the authentication manager 121, the authentication manager 121 generates terminal unshared secrets in step 406 and generates HSM unshared secrets in step 407. The terminal unshared secrets are communicated to the transaction module 105. The transaction module 105 generates a PIN input interface using the unshared terminal secrets in step 408. A PIN input interface is displayed on the display of the user terminal 123 and the user is prompted to input cursor locations. The cursor locations are input in step 409. The transaction module 105 generates corollary data using the cursor locations and the unshared terminal secrets and communicates the corollary data to the HSM interface in step 410.

The authentication manager 121 communicates the HSM unshared secrets to the HSM interface 110. The HSM interface 110 generates dynamic data based on the HSM unshared secrets and injects the dynamic data into the HSM 114 in step 411. The HSM interface 110 injects the corollary data into the HSM 114 in step 413. The HSM 114 receives the dynamic data in step 412 and the corollary data in step 414. The HSM 114 calculates a PIN using the dynamic data and the corollary data in step 415. The HSM 114 may encrypt the PIN and communicate the encrypted PIN to the HSM interface 110 in step 417.

The HSM interface 110 generates an authentication packet using the user identification information and the encrypted pin and communicates the authentication packet to the authentication authority 122 in step 417. The authentication authority 122 decrypts the PIN in step 418. The authentication uses the decrypted PIN to authenticate the user identification information in step 419. The authentication authority 122 generates a signed authentication message, where the authentication message indicates that the user identification information is authenticated or not authenticated, and communicates the signed authentication message to the authentication module in step 420. The authentication manager 121 distributes the signed authentication message to the transaction module 105 of the user that is authenticating in step 421. The transaction module 105 verifies the signature of the authentication authority 122 in step 422. The verified authentication message indicates the authentication of the authenticated user.

Authentication may operate in a number of ways. Examples of some embodiments are described with respect to the following figures. With reference to FIG. 6, an authentication system 100 is shown. When Alice's identity needs to be authenticated to Bob, Alice sends credentials to Bob. Bob sends the credentials with Alice's identification information to a trusted authenticator 606. The authenticator 606 uses the credentials and ID information to authenticate Alice's identity. The result of the authentication is sent to Bob 604. If the authenticator 606 is able to authenticate Alice's identity, Bob 604 can trust Alice 604 in accordance with Bob's trust in the authenticator 606.

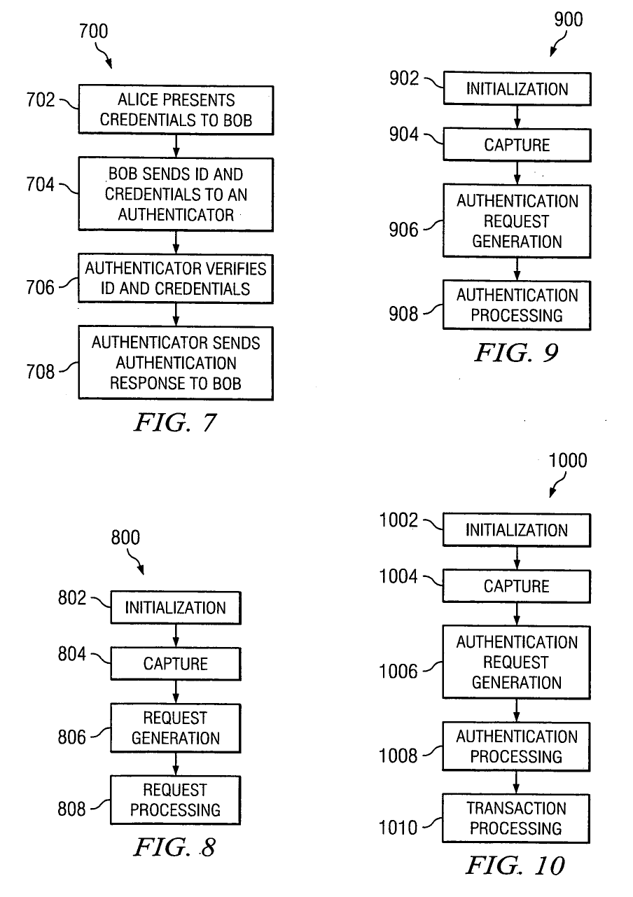

With reference to FIG. 7, an authentication process is shown. Alice presents credentials to Bob for authentication at function block 702. Bob sends ID information and the credentials to a trusted authenticator at function block 704. The authenticator verifies the ID using the credentials at function block 706. The authenticator sends an authentication response to Bob at function block 708.

With reference to FIG. 8, a PIN capture process 800 is shown. A PIN capture process 800 begins with an initialization process at function block 802. A capture process captures a PIN at function block 804 to provide authentication of the PIN after entry by a user. A request is generated using the captured PIN at function block 806 for authentication of the PIN. The request for the PIN is processed at function block 808.

With reference to FIG. 9, an authentication process 900 is shown. An initialization process is performed at function block 902. A PIN capture process is performed at function block 904. An authentication request is generated at function block 906. The authentication is processed at function block 908.

With reference to FIG. 10, a transaction authentication process 1000 is shown. An initialization process of the transaction is performed at function block 1002. The PIN is captured at function block 1004. An authentication request is generated at function block 1006. The authentication is processed at function block 1008. The transaction is processed at function block 1010.

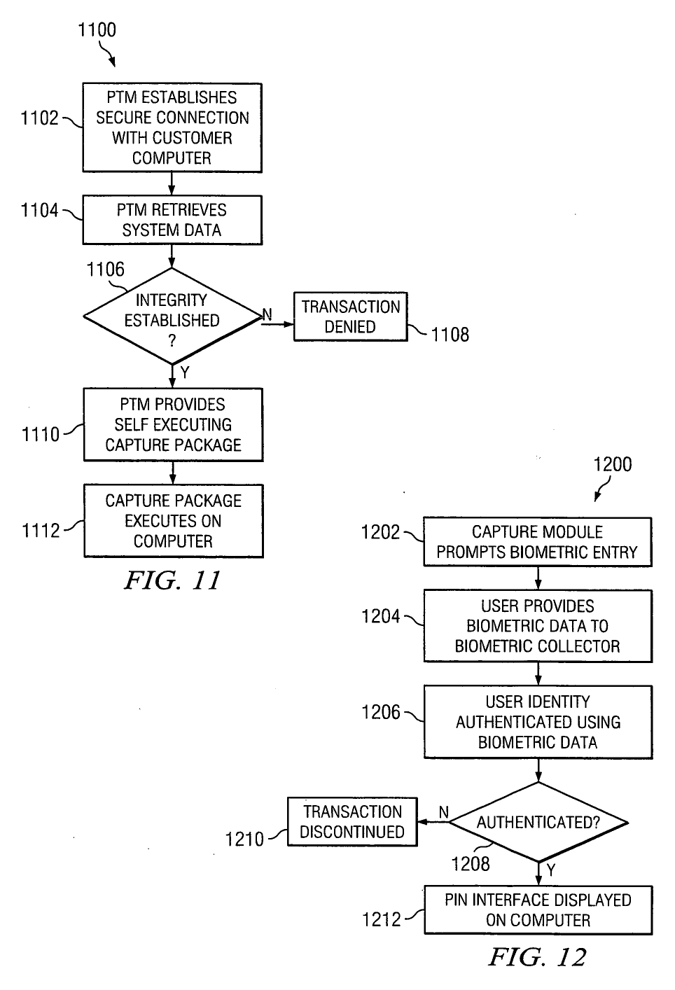

With reference to FIG. 11, a PIN capture process 1100 is shown. A PIN transaction module establishes a secure connection with a customer computer at function block 1102. The PIN transaction module retrieves system data from the customer computer at function block 1104. The PIN transaction module determines the integrity of the customer computer at decision block 1106 based upon things such as a computer locator, computer behavior, device characteristics, etc. If the customer computer is violated, the process follows the NO path and the transaction is denied at function 1108. If the computer system is secured, the PIN transaction module provides a self-executing capture package to the computer at function block 1110. The capture package executes on the customer computer at function block 1112.

With reference to FIG. 12, a biometric authentication process 1200 is shown. The capture module prompts the customer for entry of biometric data at function block 1202. The user provides biometric data to a biometric collector at function block 1204. The biometric collector may collect fingerprint, voice, IRS, facial expression, capillary behavior, blood vessel orientation, or DNA data. Other types of biometric data may also be used. The user identity is authenticated comparing the collected biometric data to stored data at function block 1206. The authentication is determined at decision block 1208. If the customer is not authenticated, process follows the NO path and the transaction is discontinued at function block 1210. If the customer is authenticated by the biometric data, the process follows the YES path and a PIN interface is displayed on the customer computer at function block 1212.

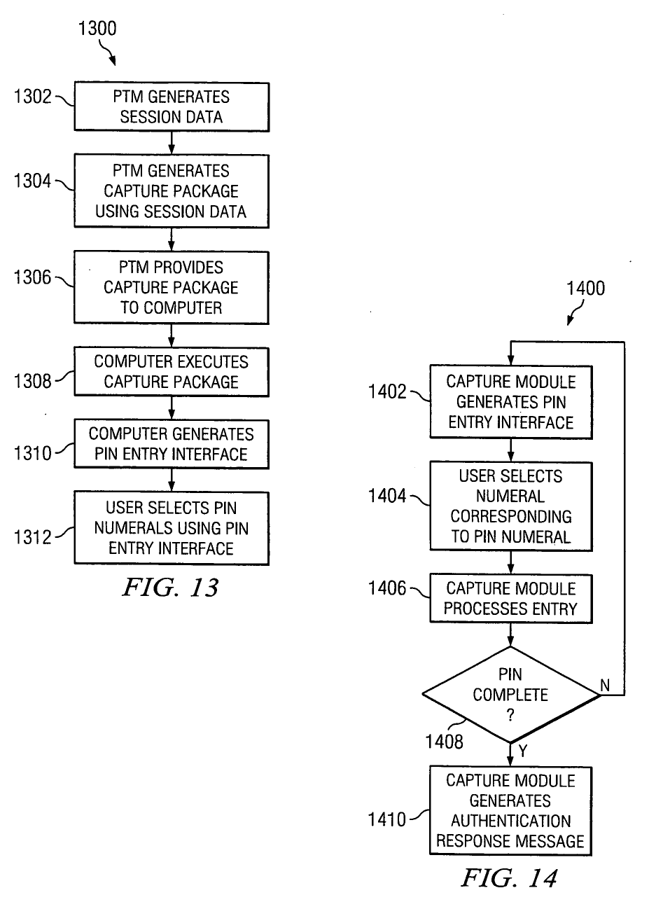

With reference to FIG. 13, a PIN capture process 1300 is shown. The PIN transaction manager 1300 generates session data at function block 1302. The PIN transaction module generates a capture package using the session data. The PIN transaction module provides the capture package to a customer computer at function block 1306. The computer executes the capture package at function block 1308. The computer generates a PIN entry interface at function block 1310. The user selects the numerals of the user's PIN on the PIN entry interface at function block 1312.

With reference to FIG. 14, a PIN capture process 1400 is shown. A capture module generates a PIN entry interface on the customer computer at function block 1402. The user selects numerals corresponding to the user's PIN at function block 1404. The capture module process the selected numeral at function block 1406. The process determines if the PIN is complete at decision block 1408. If the PIN is not complete, the process follows the NO path to function block 1402 and collects another numeral. If the PIN is complete, the process follows the YES path and the capture module generates an authentication response message at function block 1410.

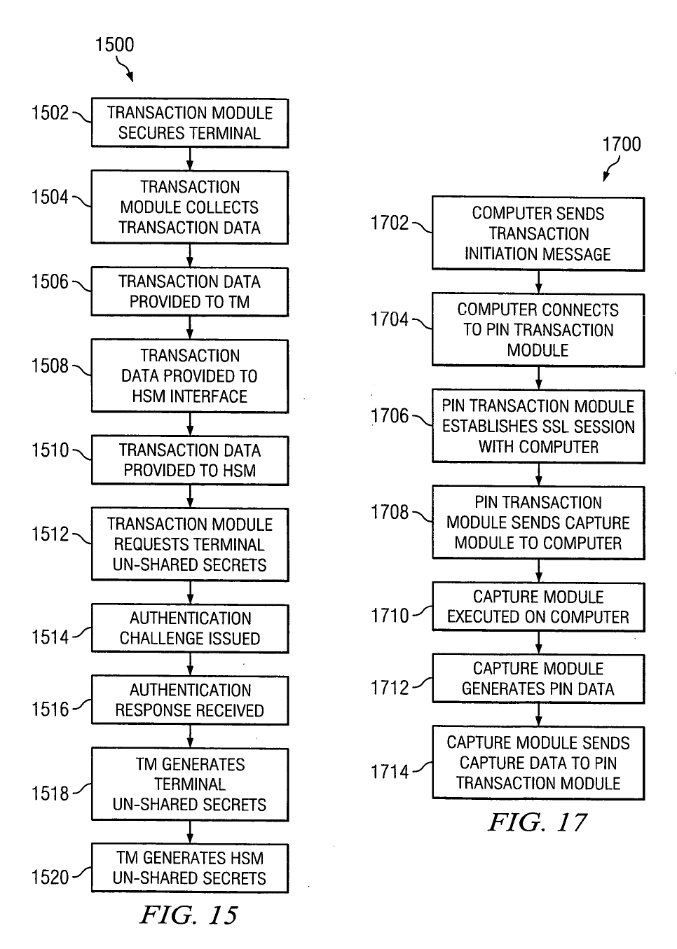

With reference to FIG. 15, a transaction process 1500 is shown. When the transaction module is executed, the transaction module performs a procedure for securing the customer terminal in step 1502. The process for securing the customer terminal may include checking the location, registry and memory of the customer terminal. The transaction module checks to see if there is any indication that the transaction process may be rendered insecure by the customer, customer software or customer hardware. A port scan is performed. The customer terminal interrupts and vectors are checked. The transaction module searches for hardware crackers. The goal is to insure that the customer terminal is a generic computer running generic software. If the transaction module determines that the customer terminal is for any reason insecure, the transaction process is terminated.

When the customer terminal is determined to be secure, the transaction module sends transaction data to the transaction manager in step 1504. Some or all of the transaction data may be sent by the transaction manager to the HSM interface in step 1506. Some or all of the transaction data may also be sent by the HSM interface to the HSM at function block 1508. The specific transaction data shared by the transaction module, transaction manager, HSM interface and the HSM depends on the particulars of the protocols underway.

The transaction module requests terminal unshared secrets from the transaction manager in step 1512. Typically, the transaction manager sends an authentication challenge to the transaction module in step 1514. An authentication response is sent by the transaction module to the transaction manager in step 1516. The interchange of authenticating data may be performed in a variety of ways. The authentication may be bidirectional, such that the transaction module is authenticated to the transaction manager and the transaction manager is authenticated to the transaction module. The authentication may take place at other times during the process, and may be repeated in some protocols. Because the identity of the participants are especially important in a financial transaction, a wide variety of authentication protocols and procedures may be implemented to accomplish that goal. The transaction manager generates terminal unshared secrets in step 1518.

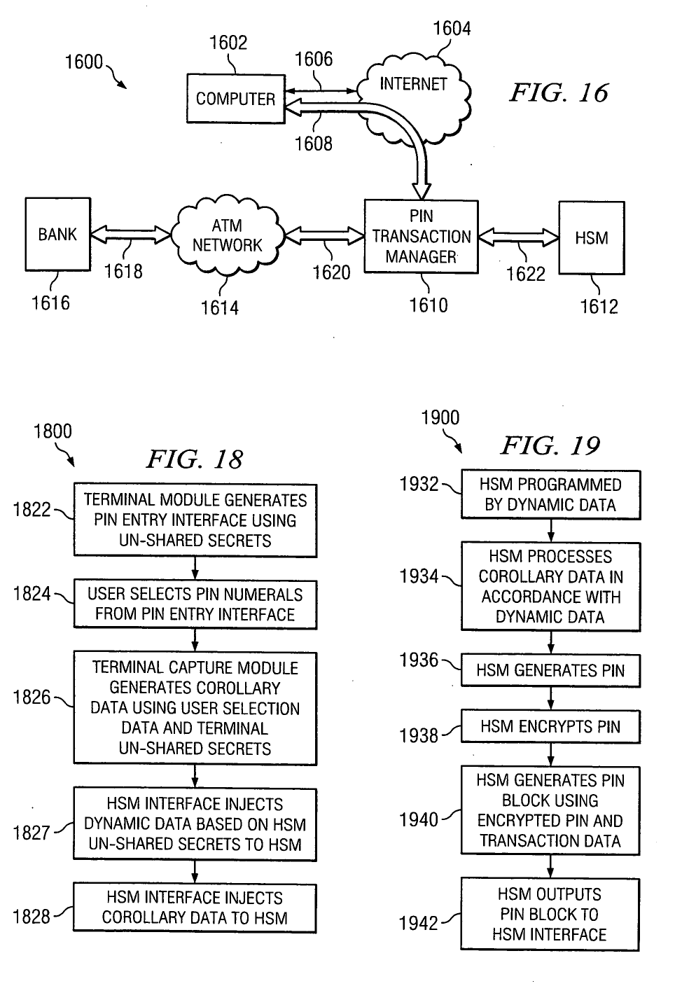

With reference to FIG. 16, a PIN transaction system 1600 is shown. A computer 1602 communicably connected 1606 to the Internet 1604 establishes a secure connection 1608 with a PIN transaction manager 1610. The PIN transaction manager 1610 is communicably connected to a security module (HSM) 1612. A customer PIN is regenerated in the security module 1612 and used to generate an ATM transaction request. The ATM transaction request is sent to a financial institution 1616 via secure network 1614 over secure connections 1618 and 1620.

With reference to FIG. 17, a PIN transaction process 1700 is shown. A computer sends a transaction initiation message at function block 1702. The computer is connected to a PIN transaction module at function block 1704. The PIN transaction module establishes an SSL session with the computer at function block 1706. The PIN transaction module sends a capture module to the computer at function block 1708. The capture module is executed on the computer at function block 1710. The capture module generates PIN data with user input at function block 1712. The capture module sends the capture data to the PIN transaction module for processing at function block 1714.

With reference to FIG. 18, a transaction process 100 is shown. The transaction manager generates HSM unshared secrets in step 1820. The terminal unshared secrets are used to allow the transaction module to properly form and encode corollary data used to identify the PIN of the customer. The HSM unshared secrets are used by the HSM to convert the corollary data into the customer PIN. The unshared secrets may include algorithms, portions of algorithms, families of algorithms, identifiers for selecting algorithms, portions of algorithms or families of algorithms. The unshared secrets may include data to modify the algorithms. Variables may be established by the unshared secrets.

The transaction manager sends the terminal unshared secrets to the transaction module and sends the HSM unshared secrets to the HSM. The transaction module generates a graphical PIN input interface for display on the customer terminal 104 using the unshared terminal secrets in step 3622. The customer selects displayed portions of the graphical PIN input interface using a mouse to generate cursor location data in step 1824. The graphical PIN input interface includes a graphical display of a numeric keypad, such the customer selects a digit of the PIN by clicking a mouse button when the mouse cursor is over the appropriate numeral. With each entered digit, the displayed keypad may be scrambled, such that a given mouse cursor location may indicate a different numeral with each entered digit. The cursor location data for each digit of the PIN is used by the transaction module to generate corollary data using the selection and the unshared terminal secrets in step 1826. The corollary data is sent to the transaction manager which further sends the corollary data to the HSM interface. The HSM interface injects the corollary data into the HSM in step 1828.

With reference to FIG. 19, a transaction process 1900 is shown. The HSM interface injects dynamic data including the unshared HSM secrets into the HSM at function block 1932. The HSM processes the corollary data in accordance with the dynamic data at function block 1934. The HSM calculates the customer PIN in step 1936.

The HSM encrypts the PIN in step 1938. The HSM generates a PIN block using the encrypted PIN and transaction data at function block 1940. The HSM sends the PIN block to the HSM interface in step 1942.

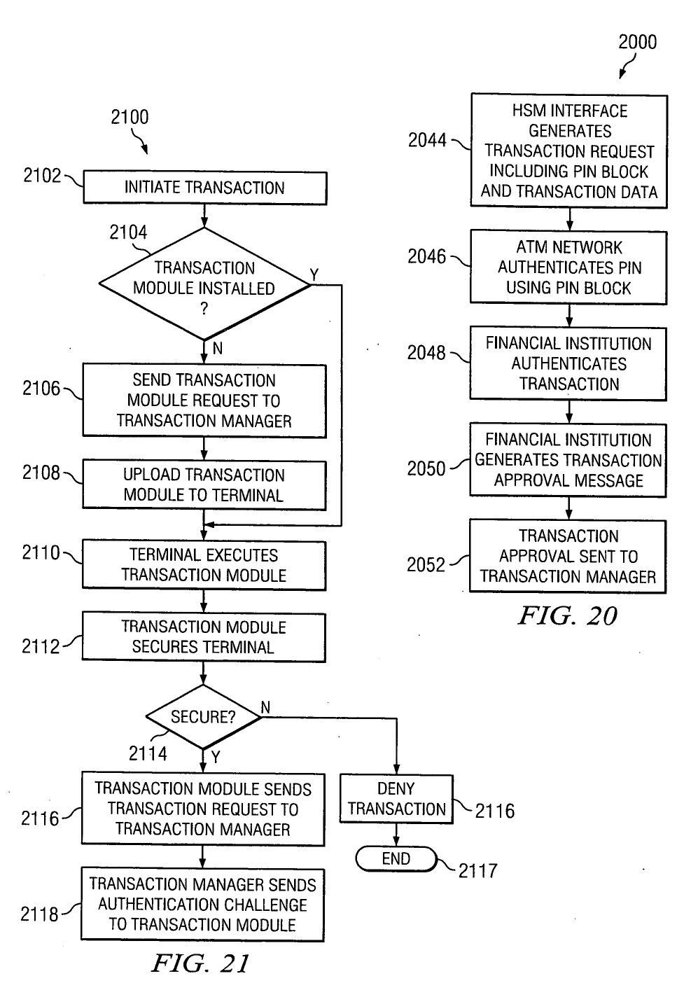

With reference to FIG. 20, a transaction process 2000 is shown. The HSM interface generates a transaction request including the PIN block at function block 2044 and sends the transaction request to the ATM Network. The ATM Network or the financial institution authenticates the PIN at function block 2046. The financial institution authenticates the transaction in step 2048. The financial institution 2020 then generates a transaction approval message at function block 2050 and sends the transaction approval message to the transaction manager at function block 2052. The transaction manager typically may notify the merchant server that the transaction has been processed.

With reference to FIG. 21, secure PIN collection process 2100 is shown. The process begins as the transaction is initiated in function block 2102. A check is done to determine if the transaction module has been installed at the customer terminal at decision block 2104. If a transaction module has not been installed, the process follows the NO path to function block 2106, sending a transaction module request to the transaction manager. The transaction manager retrieves the transaction module file from the transaction manager database and uploads the transaction module to the customer terminal at function block 2108 and proceeds to function block 2110.

If the transaction module was previously installed, the process follows the YES path to function block 2110. At function block 2110, the customer terminal executes the transaction module. The transaction module then secures the customer terminal at function block 2112. A check is made to determine if the customer terminal 104 is secure at decision block 2114. If the customer terminal is not secure, the process follows the NO path to function block 2116 where the transaction is refused. The process then ends at block 2117.

If the customer terminal is determined to be secure, the process follows the YES path to function block 2116. The transaction module sends a transaction request to the transaction manager at function block 2116. The transaction manager sends an authentication challenge to the transaction module at function block 2118.

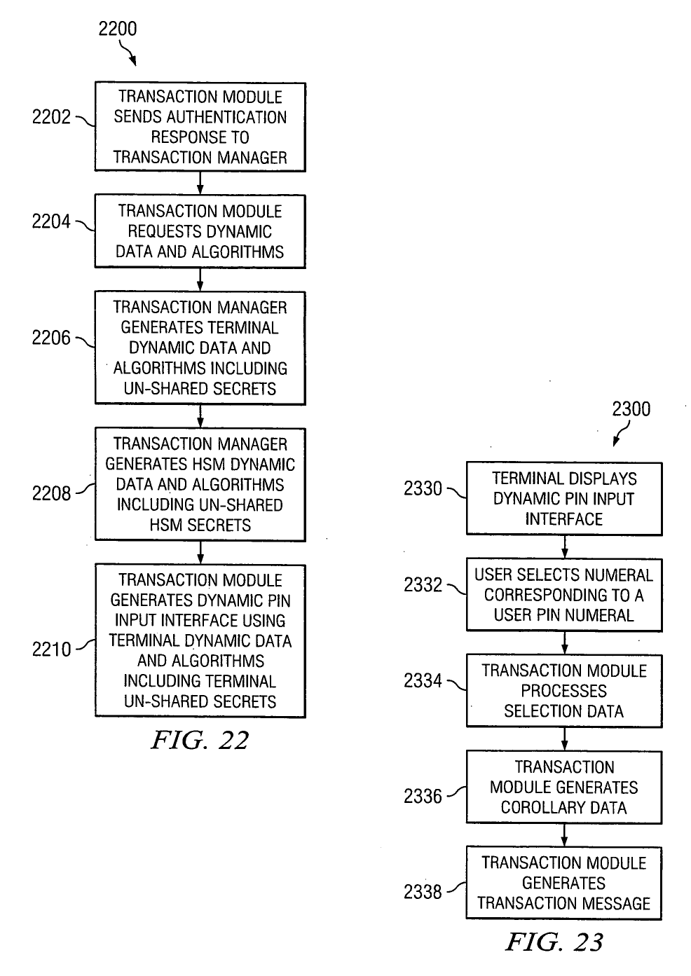

With reference to FIG. 22, a PIN collection process 2200 is shown. The transaction module sends an authentication response to the transaction manager at function block 2202. If the authentication is not verified, the transaction is refused. The transaction module requests dynamic data and algorithms at function block 2204. The transaction manager generates terminal dynamic data and algorithms including unshared terminal secrets at function block 2220.

The transaction manager generates HSM dynamic data and algorithms (DYDA) including unshared HSM secrets at function block 2208. The transaction module generates a dynamic PIN input interface using terminal dynamic data and algorithms including unshared terminal secrets at function block 2210.

With reference to FIG. 23, a PIN collection process 2300 is shown. The customer terminal displays the dynamic PIN input interface at function block 2330. The user clicks the mouse button in correspondence to the location of a cursor over displayed digits in the dynamic PIN input interface in function block 2332. The transaction module records the cursor location data at function block 2334. The transaction module generates corollary data using the dynamic data and algorithms and the cursor location data at function block 2336. The transaction module generates a transaction message including transaction data and corollary data at function block 2338.

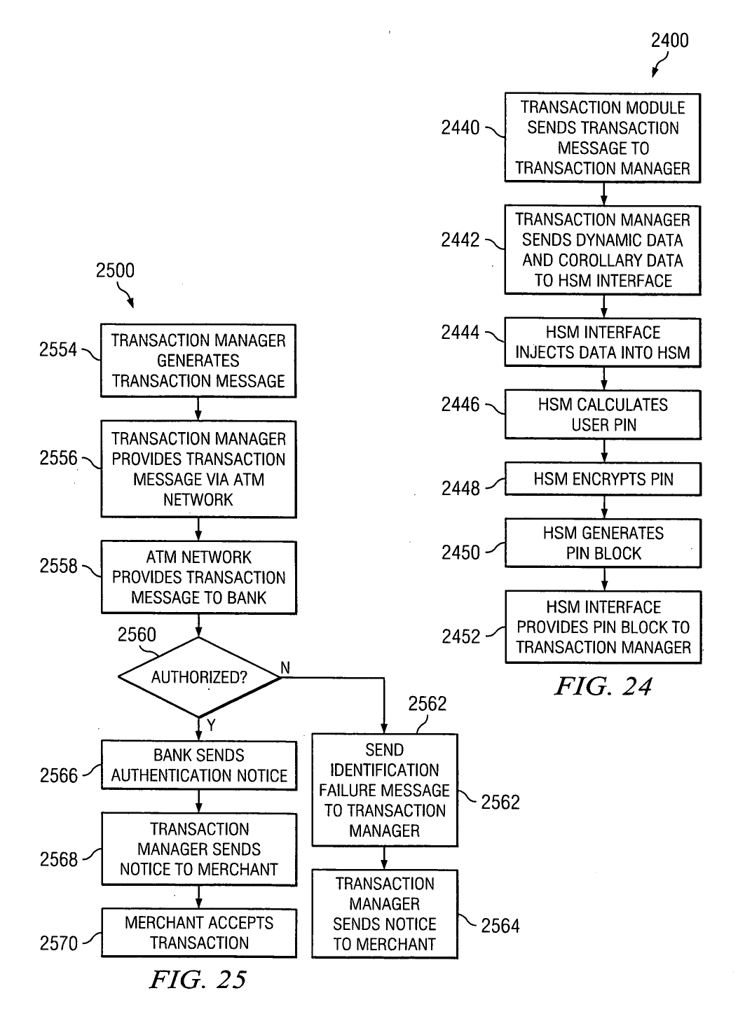

With reference to FIG. 24, a PIN collection process 2400 is shown. Proceeding to function block 2440, the transaction module send the transaction message to the transaction manager. The transaction manager sends the dynamic data and algorithms and the corollary data to the HSM interface at function block 2442. The HSM interface injects the HSM dynamic data and algorithms, seed data and corollary data to the HSM at function block 2444. Proceeding to function block 2446, the HSM calculates the customer PIN, based on the algorithms, seed data and corollary data. The HSM encrypts the PIN using an injected key-encryption-key at function block 2448. The HSM may encrypt the PIN using any of a variety of encryption techniques. The encryption may be performed using a dual-controlled, split-knowledge key, which has been injected into the HSM using a smart card. The HSM then generates a PIN block using the encrypted PIN at function block 2450. The HSM interface 110 sends the generated PIN block to the transaction manager at function block 2452.

With reference to FIG. 25, a transaction process 2500 is shown. The transaction manager generates a transaction message using the transaction data and the PIN block at function block 2554. The transaction manager then sends the transaction message to the ATM Network at function block 2556. The ATM Network sends an authorization request to the Financial Institution at function block 2558.

At decision block 2560, the financial institution determines if the transaction is authorized. If the transaction is not authorized, the process follows the NO path to function block 2562 where financial institution may send a “transaction denied” message to the transaction manager. The transaction manager may send a “transaction denied” message to the merchant server 108 at function block 2564.

If the transaction is authorized, the process follows the YES path to function block 2566. The financial institution sends a “transaction approved” message to the transaction manager at function block 2566. The transaction manager sends a “transaction approved” message to the merchant server. The financial institution debits the customer's account in accordance with the transaction data at function block 2570.

The secure PIN processing system may serve as a part of an on-line commercial transaction process. It should be understood that the secure PIN processing system may be used in other network transaction environments, typically in processes where a party must be authenticated without the insecure transfer of authenticating data. A personal identification number (PIN) is a sequence of numerals, where the number of digits creates a sufficiently high probability that a person in possession of the PIN can be positively identified as a specified person. PIN are most commonly used in association with bank debit cards. Bank debits cards are used at automated teller machines (ATM) connected to the ATM Network. When the customer presents the card to the ATM, the ATM prompts the customer to enter a PIN. The customer enters the PIN into the ATM. The ATM processes the PIN and data read from the bank debit card to identify the customer presenting the card as the legitimate owner of the card. The process for PIN-based transactions with debit cards at ATM is heavily regulated.

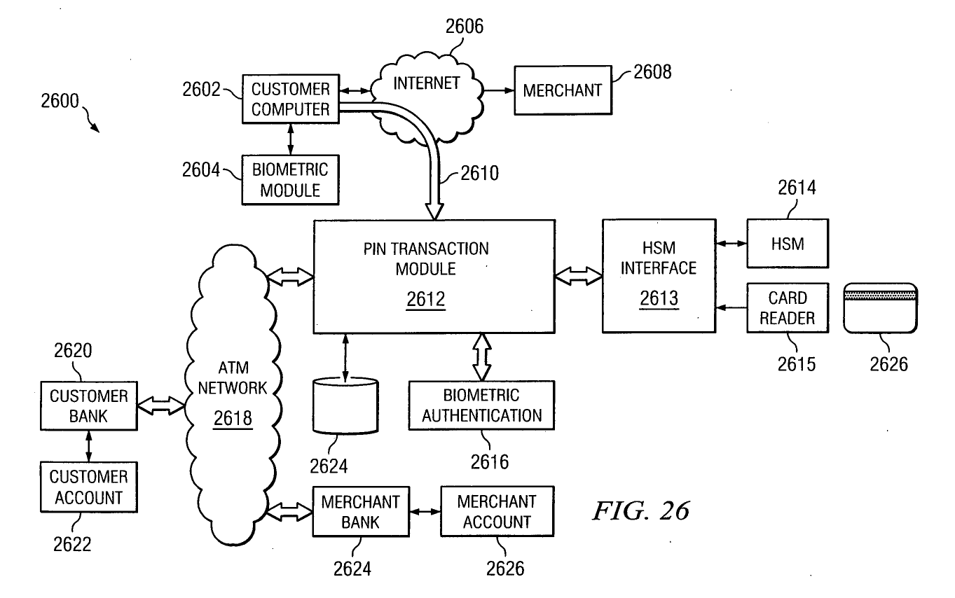

With reference to FIG. 26, a PIN transaction system 2600 is shown. A customer computer 2602 including a biometric module 2604 connects to a merchant 2608 over network 2606. The customer computer 2602 is securely connected to a PIN transaction module 2612 with SSL connection 2610. The PIN transaction module is securely connected to a security module 2614. Biometric authentication 2616 may provide information to the PIN transaction module 2612. A secure network 2618 provides messages from PIN transaction module 2612 to the customer bank 2620. Monies may be transferred from customer account 2622 at customer bank 2620 to the merchant account 2626 at a merchant bank 2624.

Typically, the customer at the customer terminal 2602 is connected to a merchant server 2608 via the Internet 2606. The merchant server 2608 may offer goods or services for sale to the customer, with one or more web pages serving as consumer interfaces. When the customer has made appropriate selections at the merchant web site, payment options are typically given to the customer. Communication between the customer terminal 2602 and the merchant server 2608 will typically be conducted using a secure socket layer (SSL) connection, although the security of the transaction communication may be in accordance with another protocol or even made in the clear, depending on the security needs dictated by the specific transactions and protocols. In accordance with the present embodiment, when a debit-type transaction where money is transferred from a customer bank account at a financial institution 2620 via the ATM network 2618 is selected, the transaction is initiated, typically by a transaction initiation message sent from the customer terminal 2602 through the open network 2606 to the merchant server 2608.

When a transaction initiation message is received at the merchant server 2608, the merchant server 2608 communicates the transaction initiation, including transaction details, merchant details and customer details, to the transaction manager 2612. Communications between the merchant server 2608 and the transaction manager 2612 are typically conducted using a dedicated communication network or a virtual private network (VPN). Some communications between the merchant server 2608 and the transaction manager 2612 may be conducted via the open network 2606, but because of the confidential nature of the financial transaction, communication between the merchant server 2608 and the transaction manager 2602 will typically use a secured connection.

The merchant server 2608 will establish a connection between the customer terminal 2602 and the transaction manager 2612. This connection will typically be established in such a way that the customer at customer terminal 2602 is generally unaware that the customer is communicating with the transaction manager 2612 instead of the merchant server. However, once the connection is established between the customer terminal 2602 and the transaction manager 2612, the merchant server 2608 is privy to none of the data exchanged between the customer terminal 2602 and the transaction manager 2612. This protocol prevents the merchant server 2608 from intercepting the communications between the customer terminal 2602 and the transaction manager 2602 and gaining access to confidential financial or personal data, as well as preventing man-in-the-middle attacks on the system.

The transaction manager 2612 is communicably connected to a transaction manager database 2624. The transaction manager database 2624 stores algorithms and other data used in the transactions. When the customer terminal 2602 initiates a first transaction, the transaction manager 2612 retrieves a copy of a transaction module from the transaction manager database 2624 and sends a transaction module to the customer terminal 2602. The transaction module secures the customer terminal 2602 and regulates the transaction process at the customer terminal 2602.

The transaction manager database 2624 may store algorithms used to generate a dynamic PIN input interface, encryption algorithms, components of encryption algorithms and other data used as unshared secrets. The algorithms and data stored in the transaction manager database may be organized in families of data, such that when a DDA family is available to a transaction module, the processing steps may be chosen by identifying portions of the DDA family and with data to determine the variables used in the creation of corollary data.

The transaction manager 2624 is communicably connected to a Hardware Security Module (HSM) interface 2613. The HSM interface 2613 may be a secure configuration terminal (SCT). The connection between the transaction manager 2612 and the HSM interface 2613 is typically a secured line connection. The HSM interface 2613 is connected directly to an HSM 2614. The HSM 2614 or the HSM interface 2613 may include an card reader 2615 for reading data from a key card 2626.

In accordance with the preferred embodiment, the Hardware Security Module 2614 is a programmable or intelligent HSM. A programmable HSM is, generally, an HSM that is capable of interpreting injected data as programmatic instructions. Programmatic instructions may refer to executable images like an application written in a programming language such as assembly code, C or C++. Runtime images like a JAVA application may be used as programmatic instructions.

By programming the intelligent HSM 2614, the HSM 2614 may implement programmed behavior either statically or dynamically. In this way, the HSM 2614 may be programmed to securely interact with the cryptography functions of the HSM 2614. Applications may be downloaded into the HSM 2614 using any secure methodology. For example, the applications may be input into the HSM 2614 using a serial port, a network adaptor, smart cards, floppy disks, cd-roms, an infrared port or any other known input mechanism. In accordance with the preferred embodiment, a smart card 2626 may be used to inject algorithms, keys or other secure data into the HSM 214.

The executable code injected into the HSM 2614 is typically authenticated using a digital signature of the executable code generated by an authorized publisher. Other authentication methods may be used. The executable image, when executed, is programmed so that data is exchanged between the HSM 2614, the HSM interface 2613 and other connected systems in a secure manner. In particular, the programming prevents compromise of the HSM 2614 including the algorithms and keys stored therein. The HSM 2614, in accordance with the preferred embodiment, is capable of both reading and writing to smart card 2626.

The HSM 2614 may be a Tamper Resistant Security Module (TRSM), preventing physical as well as logical intrusion. Using approved software components, a customized secure configuration terminal (SCT), ACL definitions, policies and procedures, the programmable HSM 2614 can be made to meet X9 key management requirements. In particular, the HSM 2614 can perform X9 compliant key exchange keys, split knowledge key management, dual control, key fragments, key pair generation, key injection, key combining, key exchange, key loading, key recovery, destruction of keying material, key management with encrypted keys, PIN block creation, PIN block translation, PIN management with encrypted PIN. The HSM 2614 may be an X9 compliant tamper proof enclosure with key destruction when the enclosure of the HSM has been compromised. Policies and procedures for these processes are made auditable and verifiable.

The HSM 2614 may be encased in a durable, tamper-resistant casing to protect the system against intrusion, with built-in detection features capable of sensing sophisticated attempts at physical or electronic tampering. An unauthorized attempt to access the HSM results in the immediate and automatic erasure of the secured algorithms and data stored in the HSM 2614. The HSM 2614 is a TRSM capable of enforcing key confidentiality and separation. The HSM 2614 allows dual control, tamper detection and active countermeasures such as automatic key erasure upon compromise. These types of devices and environmental security measures currently exist in many systems of financial institutions, network processing centers and military installations.

The HSM 2614 may also use access control lists to allow fine-grained control over key separation, key injection and key management. The HSM 2614 will preferably be programmed so that it will only accept authenticated trusted code provided by an authenticated trusted publisher. Authentication of the trusted code and trusted publisher is typically achieved using an appropriate digital signature authentication protocol.

The HSM 2614 may be programmed to refuse to load trusted code during key loading processes. The HSM 2614 may be programmed to restrict code loading in accordance with X9 audit procedures. The HSM 2614 should pass FIPS-140 validation requirements. The HSM 2614, in conjunction with an SCT and approved key management practices allow for the management of keys for injection into devices that are physically or geographically separate, as may be required for business continuance best practices. The HSM 2614, in conjunction with an SCT, can meet or exceed all key management practices required by the X9 TG-3 audit guidelines or associated standards.

To make the HSM 2614 compliant with X9 requirements, the programmed HSM 2614 requires that private keys and symmetric keys exist inn an acceptable secure format. The keys may be rendered as clear inside the protected memory of a tamper resistant security module, or encrypted when rendered outside of the protected memory of a tamper resistant security module. The keys may be rendered as two or more key fragments or key components either in clear or ciphertext and managed using dual control with split knowledge fragmentation of the keys. Secret-sharing enables the key fragments to be stored separately on tokens so that less than all of the key fragments (k-of-n key fragments) are required to load or reconstitute the key being protected. Good security practice requires key separation, whereby each key or key pair is generated for a particular purpose and used solely for the purpose for which it was intended.

The HSM interface 2613 may be interfaced directly or indirectly with the HSM 2614 for loading the key-encryption-key (KEK), key pairs as well as any other activity necessary to meet X9 standards for key management. Accordingly, the HSM interface 2613 may be connected directly to the HSM 2614, for example using an SCSI, IDE, serial port, parallel port, USB port, keyboard, mouse, or firewire port. The HSM interface 2613 may be connected indirectly to the HSM 2614, for example using an infra-red port. The HSM interface 2613 may be interoperable with the HSM 2614 via use of smart cards with supporting processes and procedures to insure key management policies and procedures can be implemented. Future connection methodologies that comport with the required standards may also be used.

The HSM interface 2613 may be encased inn a durable, tamper-resistant casing to safeguard the system against incursion. The HSM interface 2613 should also include built-in detection techniques capable of sensing sophisticated attempts at physical or electronic tampering. These techniques may provide for immediate and automatic erasure of secured algorithms and data stored in the device.

In accordance with one embodiment, the HSM interface 2613 may provide graphics display, allowing it to support a variety of graphic character sets, including Japanese, Chinese, Arabic and Cyrillic-based languages. The display may be configured to show two lines of Chinese prompts, two lines of large characters or up to four lines of Roman text. The HSM interface 2613 may be capable of displaying two languages simultaneously, such as French and English, for use in multi-lingual environments.

The HSM interface 2613 may be configured to support custom application development and remote downloading of an executable image. The download process will typically require a trusted code source and use executable code that is authenticated, through a digital certificate, hash, MAC or other methodology sufficient to prove the authenticity and integrity of the executable code.

The HSM interface 2613 may provide access control using smart cards, token devices, passwords or other methodology. Access control is used to insure that code downloads can only be accomplished by authorized trusted entities. Use of the HSM interface 2613 may be restricted using access control. Key loading is restricted to authorized parties using access control. Key injection is restricted to authorized parties using access control. Software download is restricted to proprietary protocols and otherwise restricted using access control.

The HSM interface 2613 insures that access to any keying information entered can not be controlled or denied to one or all users of the HSM 2614. The HSM interface 2613 may provide an interface for the HSM 2614. The HSM interface 2613 may provide simultaneous support for multiple key management functions. The HSM interface 2613 may provide comprehensive software security and tamper-proof casing. The HSM interface 2613 may store keys securely in a security chip. The HSM interface 2613 may include the ability to wipe keys from the security chip upon completion of keying activity if required. The HSM interface 2613 may provide secure communications between a keyboard, a display and a security module. The HSM interface 2613 may provide a PIN pad that supports alpha-numeric entry. The HSM interface 2613 may provide a smart card reader and writer supporting a plurality of asynchronous and synchronous memory and protected-memory cards. The HSM interface 2613 may include a magnetic strip reader that can read and write Track 1 and 2 or Track 2 and 3. The HSM interface 2613 may provide a serial interface.

The HSM interface 2613 smart and magnetic card reader 2615 may provide a secure and verifiable erasure feature to insure no residual keying material exists after keys have been injected or keying material has been discarded. This may be implemented as a procedure that requires erasure of the material be performed and verified to substantive level. The card reader and writer 2615 may support both EMV for smart card support, debit cards, credit cards, and ATM cards.

The HSM interface 2613 may be both physically and electronically secure, and may contain an integral security module, with an encryption chip, that offers simultaneous support for encryption and key management functions. The security module may be provided to work with DES, Triple DES, ECC, AES, RSA encryption, and supports Master/Session Key, DUKPT (derived unique key per transaction) and regional key management methods.

The HSM interface 2613 may provide additional features that are not required to secure the HSM 2614, as the device may include higher order utility capabilities for acting as a PIN pad in online and offline debit transactions.

The HSM interface 2613 is communicably connected, typically by a secure line connection, to a closed network 2618 such as the ATM Network. This closed network 2618 provides communication to one or more financial institutions 120. Transaction for the transfer of monies from one account to another is performed by communications transmitted through the ATM Network 2618.

In typical prior art systems, using software-based cryptography, all of the cryptographic components (i.e., algorithm, key, clear, ciphertext) reside in unprotected memory, where they are susceptible to duplication, modification, or substitution. The most susceptible element is the cryptographic key. A duplicated key allows an attacker to recover all encrypted data. In addition a duplicated asymmetric private key allows an adversary to falsely generate digital signatures that would be attributed to the computer owner. A substituted or modified public key would allow a “man-in-the-middle” attack such that the adversary could intercept and change e-mails or transaction data undetectable by the sender or receiver.

In the hardware-based cryptography, physical and logical barriers limit data access, while the algorithm and key are kept secure in the protected memory of the HSM 2614. Thus, hardware based cryptography ensures the confidentiality, integrity, and authenticity of cryptographic keys and, further, provides assurance regarding the integrity and authenticity of the cryptographic algorithm, which reinforces the overall level of security.

The secure PIN processing system 2600 insures that the key management policies, practices and lifecycle controls which deal with an organization's policies and practices regarding the management of private asymmetric keys, symmetric keys, and other types of keying material (e.g., pseudo-random number generator seed values), including cryptographic hardware management. Key management life cycle control information should be disclosed to allow relying parties to assess whether the organization maintains sufficient controls to meet its business requirements and insure key generation practices, such that cryptographic keys are generated in accordance with industry standards.

The secure PIN processing system 2600 manages the random or pseudo-random number generation process, prime number generation, key generation algorithms, hardware and software components. The secure PIN processing system maintains adherence to all relevant standards as well as references to the key generation procedural documentation including key storage and backup. Asymmetric private keys and symmetric keys remain secret and their integrity, authenticity and recovery practices may be retained. The secure PIN processing system 100 allows the use of key separation mechanisms using hardware and software components. This permits provable adherence to all relevant standards and provides references to key storage, backup, and recovery procedures. The secure PIN processing system 2600 controls the initial key distribution processes, subsequent key replacement processes, and key synchronization mechanisms.

The secure PIN processing system 2600 relies on the HSM 2614 not just for security by also to insure the cryptography which is CPU intensive is optimized for high scalability and is capable of supporting diverse applications. The secure PIN processing system and process 2600 may dramatically increase the number of cryptographic keys generated, distributed, installed, used, and eventually terminated. This proliferation will stress the scalability of key management software and the key storage mechanisms that will be forced to manage more and more cryptographic keys.

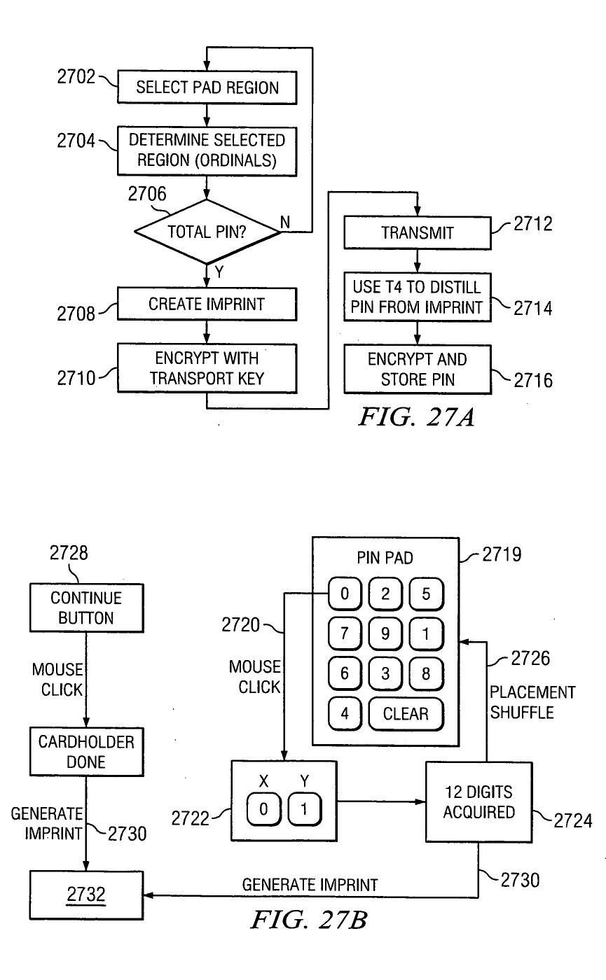

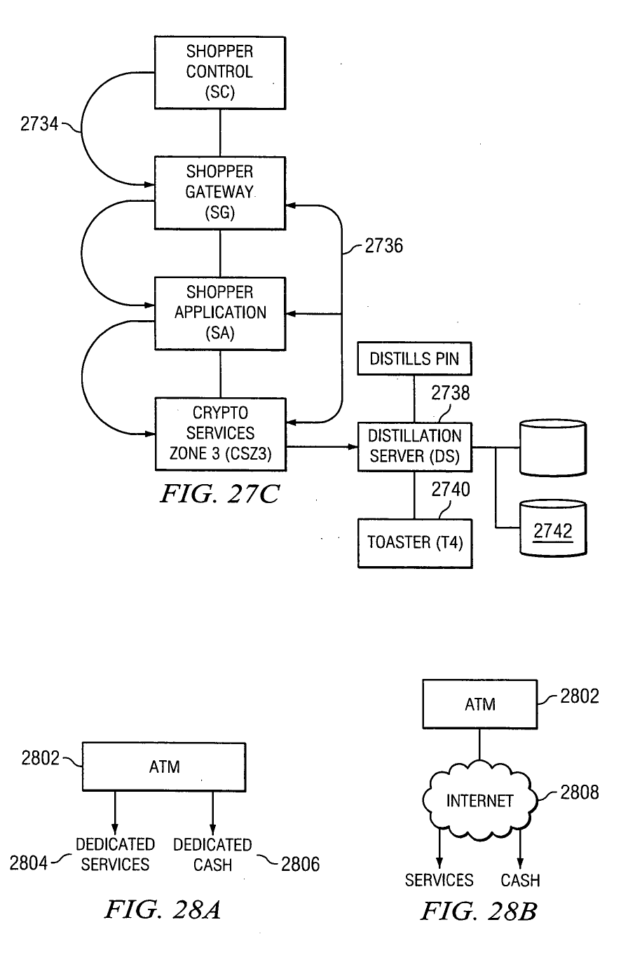

Referring now to FIG. 27a, there is illustrated a flow diagram describing the manner in which an imprint is generated and transmitted between a transaction module 105 and an authentication authority 121. This imprint and transmission procedure provides a method where the acquisition of data by a graphical interface or mouse enables data to be selected and a nonspecific imprint created of the data that may be transmitted over an outside secure line. The data may comprise for example a PIN, a nonspecific imprint does not in and of itself provide the selected data entered by user. Thus, if the nonspecific imprint were to be intercepted by an unauthorized party the user selected data would not be discernable to the unauthorized party. The nonspecific imprint may then be received at the authentication manager 121 and the data selected by the user extracted from the nonspecific imprint such that this data may be injected or stored with secure data without exposing the user selected data to the outside world.

Initially the user selects a pad region on the user interface at step 2702. Within the transaction module 105A the selected region is then determined. At such that the ordinals the region selected may be established at 2704. Inquiry step 2706 determines if the complete data entry has been received. In this example, a PIN number is used such that a determination is made if the total number of numerals for the PIN have been selected. If not, control passes back to 2702 where in a next pad region is selected. Once all of the data has been selected, an imprint of this data may then be created at 2708. The imprint comprises a nonspecific graphical representation of the data selected by the user. The imprint is encrypted with a transport key at 2702 and its been transmitted step 2712 from the transaction module 105 to the authentication manager 121. A “T4” security module is used to distill the user selected data from the imprint at 2714. The distilled user data is encrypted and stored at 2716 within the security module such that the user data is not excisable to the external world.

Referring now to FIG. 27B, there is more fully illustrated the process for generating the imprint discussed with respect to FIG. 27A. Initially the user selects a pad region of a graphical interface that collates to a region occupied by the pin pad using for example, a mouse click at 2720. The sauce application evaluates wether this selected region is valid. If the selected region is valid, the coordinates are retained, referred to as an ordinal value at 2722. The ordinal value comprises an XY value that is associated with a particular location on the pin pad 2719. The client evaluates wether 12 sets of ordinals have been established, and if not the client requests that the sauce application generates another unique placement shuffle of the components on the pin pad 2719. This process occurs at 2724 and 2726. Once it is determined at 2724 that 12 ordinals are acquired, or when a card holder elects to press the continue button at 2728, an imprint is generated at 2730. The creation of the imprint involves the ordinals and the numbers of hits being assembled in a 128 bit block pads. The pads will be placed into a pre-allocated message block called the imprint data 2732.

Referring now to FIG. 27C, there is more fully illustrated, the process for transmitting imprinted data. Once the shopper control has generated a digital imprint from consumer mouse clicks as described in FIG. 27B, the shopper encrypts the digital imprint at 2734 with the imprint transport key. Next, at 2736, the shopper sends the encrypted imprint to the distillation server 2738. The distillation server uses T4 to distill the PIN from the digital imprint and T4 converts the PIN into PIN PAN at 2740. The PIN block is encrypted and placed within the data store 2742, and the pin block is automatically deleted from the data store 6942 three business days after its generation.

Referring now to FIGS. 28A, 28B, they are illustrated one manner in which the authentication system described here above may be utilized within an open network environment in order to more effectively provide various products and services to authorize individuals. FIG. 28A, illustrates an ATM device 2802 wherein the ATM device has the ability to provide various services to an authorized user and also provide cash to authorized individuals. In the example illustrated, the services provided by the ATM 2802 are provided through a dedicated service line 2804. The dedicated service line requires the installation and of a specific services line network. Likewise, the ATM 2802 includes a dedicated cash line 2806 for providing cash to users. Thus, the dedicated services line 2804 requires the installation of a specific support into infrastructure for providing the cash to an individual. FIG. 28B illustrates an alternative a embodiment wherein the ATM machine 2802 rather than being connected to a dedicated services line 2804 and a dedicated cash line 2806 is connected directly to the Internet 2808. Using the authentication processes described herein, the ATM 2802 rather then transmitting the cash services to individuals over dedicated cash and service lines, instead utilize an authenticated in secure ATM 2802 to transmit cash and services directly to and secure, authenticated users through the Internet 2808. This would greatly reduce the cost involved with providing dedicated service lines 2806 and dedicated cash lines 2804 and the necessary network in infrastructure associated there with.

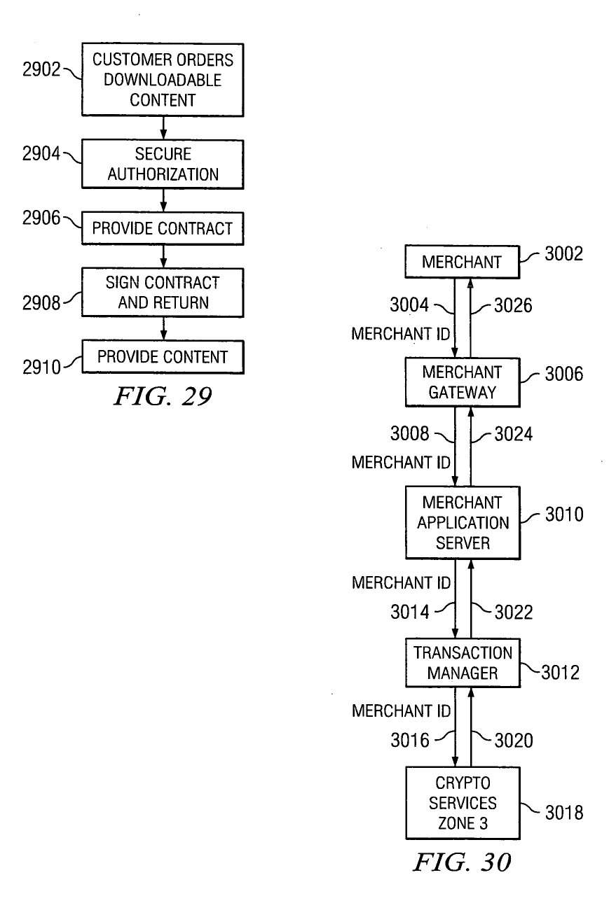

Referring now to FIG. 29, there is illustrated a flow diagram describing a process where a customer and a content provider may benefit from an authentication process describe herein above. Initially, at 2902, a customer will order a particular content from a content provider. The content provider may comprise for example a record company provider such as Virgin Records. The customer may select a particular song or album to download. Other types of content providers can include software providers, graphic providers, movie providers, or any other type of material that may be downloaded on the Internet over an authorized point to point connection. Once the customer this requested the downloadable content, the security and authorization are established at 2904 to provide a trusted network connection. The customer is provided a digitally signable contract from a connect provider. The contract establishes that if the user downloads the selected downloadable contents they agree not to further disseminate the downloaded content to addition individuals. This would require that the downloadable content had some type of tracking information associated with that was unique to the customer such that unauthorized copies of the downloadable content could be tracked back to the customer if the agreement was violated. The contact is further digitally signable by the customer such that a legal and binding contract that is enforceable against the customer may be established between the customer and the content provider. If the user agrees the contract is signed at 2908 and the signed contract is returned back to the content provider to complete the contractual obligation between the customer and the content provider. The content provider may then provide at 2910 the content to the customer for use only by the customer. The customer then will be obligated to the contract signed by them and the content provider will have endorsable documentation useable against the customer should the occasion rise.

Referring now to FIG. 30, there is illustrated a manner in which the authorization process described above may be used to establish signing keys for a merchant. Initially, a merchant system 3002 retrieves or generates signing tokens presented by an authorization entity during initiation of a transaction. The merchant registers at 3004 and the merchant gateway receives the HTTP message and constructs a proprietary message and forwards the message to the merchant application server at 3008. The application server 3010 verifies that the merchant ID is valid and forwards the message to the transaction manager 3012 at 3014. Transaction manager 3012 forwards at 3014 the message to the crypto server 3018 for processing. The crypto server 3018 retrieves or generates a digital certificate for signing. The crypto server 3018 stores the provided digital certificate for retrieval and signature verification. The crypto 3018 transmits the digital certificate to the transaction manager at 3020. The transaction manager transmits the message to the merchant application server 3010 at 7022. The merchant application transmits the message to the merchant gateway 3006 at 3024, and the merchant gateway 7306 forwards at 7326 the message to the merchant 7302 after converting to the message to an HTTP message format. The merchant will then store the received sign and key.

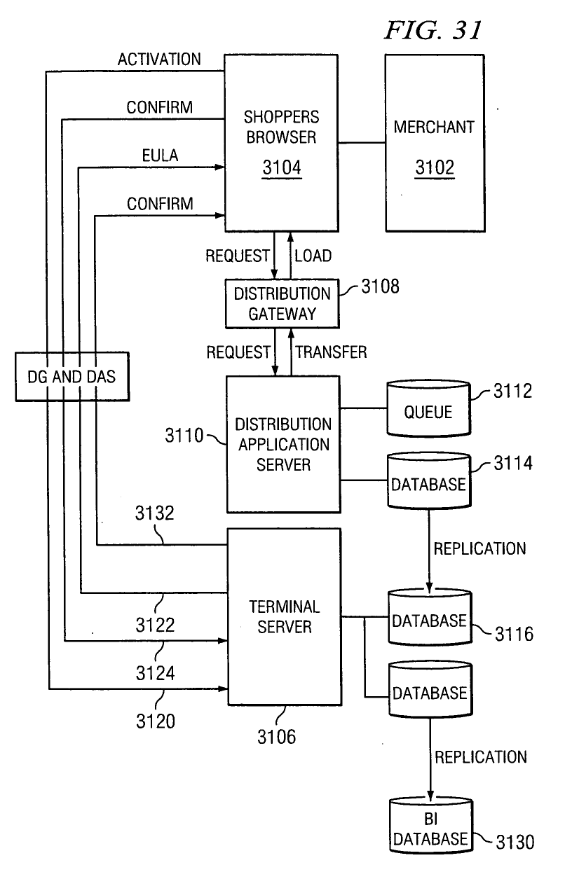

Referring now to FIG. 31, there is illustrated a method using the describing authentication system for the distribution of software. The merchant 3102 using the transaction manager application program interface, receives an indication that the shopper does not have the transaction manager software on their desktop. The merchant 3102 directs the consumers browser 3104 to download software from the transaction manager terminal server 3106. The distribution gateway 3108 responds to the request and instructs the distribution application server 3110 to repair a new software component package for delivery to the shopper. The distribution application server 3110 extracts the software component from the Que 3112 and updates the data base 3114 to reflect the delivery of another unique piece of software. The data base 3114 operating on the distribution application server 3110 replicates information to the terminal server data base 3116. The distribution application server 3110 transfers the unique component to the distribution gateway 3108. The distribution gateway 3108 responds to the browser request by delivering the unique component to the browser 3104. The browser 3104 prompts the user to accept the component from the terminal server 3106. The consumer may elect to always trust the terminal server 3106 and as such will be prompted. An activation software component request is transmitted from the browser 3104 to the terminal server 3106 at 3120. The distribution gateway 3108 routes a request to the distribution application server 3110, which routes the request to the terminal server 3106 the distribution gateway 3106 routes the request to the distribution application server. The distribution application server routes the request to the terminal server 3106. The terminal server 3106 responds with the current EULA e(End User License Agreement) at 3122 to display the terms and conditions for the software. The distribution gateway routes the request to the distribution application server 3110 and then on to the terminal server 3106. The terminal server records acceptance within the data base 3116. Confirmation is transmitted back from the browser 3104 at 3124. The data base 3116 performs an automated replication to the data base 3130. A confirmation message is sent back to the shopper browser from the terminal server 3106 at 3131.

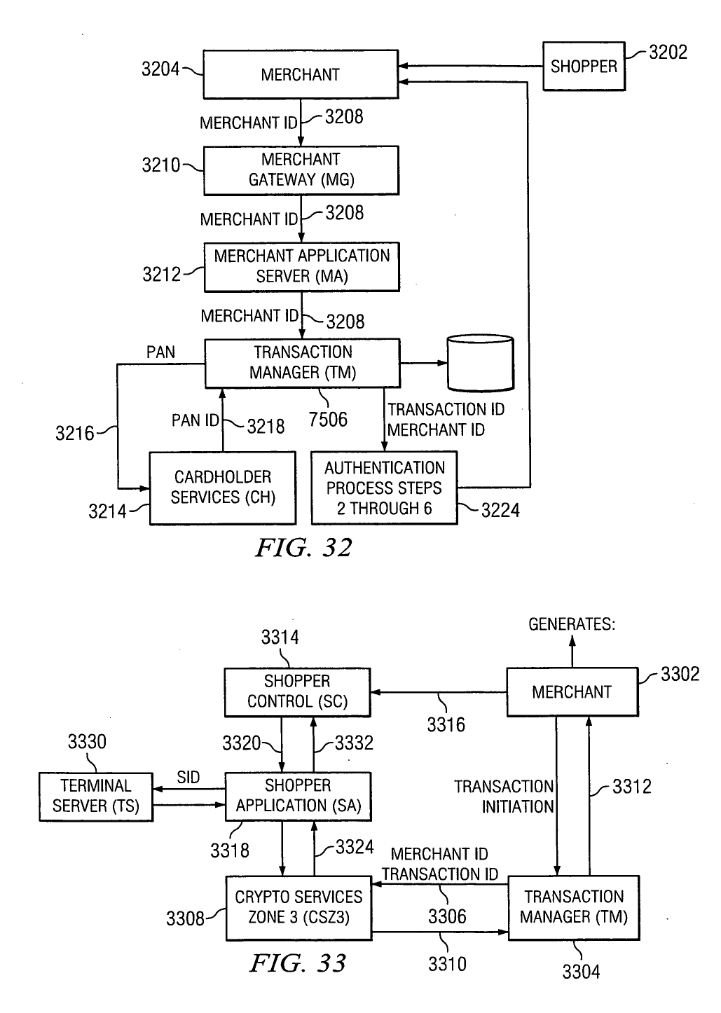

Referring now to FIG. 32, there is illustrated a process for initiating a transaction between a shopper 3202 and a merchant 3204 using the authentication process of the present disclosure. The shopper 3202 is in a shopping cart of a merchant 3204 and has elected to pay with a PIN debit. The merchants commerce system utilizes a transactions manager 3206 application program interface to request a new transaction contact by invoking a transaction including the merchant ID, PAN, order number and amount. The request is transmitted from the merchant 3204 to a transaction managers 3206 in a series of requests 3208 transmitted from the merchant to the merchant gateway, from the merchant gateway to the merchant application server, and from the merchant application server to the transaction manager. The transaction manager requests from the card holder services 3214 data. Card holder services 3214 provides at 3218 a data package back to the transaction manager 3206. The transaction manager 3206 will generate a transaction ID which may be a 24 bit key including the merchant ID. The transaction manager 3206 will store the transaction ID for uses as the primary key for all transactions. The transaction manager 3206 sends the merchant ID and transaction ID to the authentication ID to initiate the authentication process at 3224.

Referring now also to FIG. 33, there is more fully described the authentication process. The merchant 3302 requests a new transaction from the transaction manager 3304. The transaction is routed through the merchant systems to be serviced by the transactions manager 3304. The transaction manager 3304 initiates a new transaction and request crypto services at 3306 to create a key pair for use in a PKI session. The crypto services 3308 may utilize a key pair for use in signing tokens. Crypto services 3308 push the at least one signed token to the transaction manager 3304 at 3310. The transaction manager 3304 sends the signed token through the merchant application server and gateway to the merchant 3302 at 3312. The merchant signs the signed token with its signing key and pushes the merchant token to the shopper control 3314 at 3316. Shopper control 3314 creates a key pair. The shopper control 3314 extracts and verifies the software. The shopper signs the merchant token. The shopper 3314 sends a public key to the shopper application 7018 at 7020. The shopper application 7018 sends at least the key shopper token to the crypto services 7008. The crypto services 7008 uses the provided information to generate the session key and verifies the signatures presented by the shopper merchant. The crypto services 7008 obtain the identification data and then pushes the value to the shopper application 7018 at 3324. The shopper application 3318 request from the terminal server 3330 validation of the software application being active. The terminal server 3330 provides the proper authentication to the shopper control 3314 or terminates the session at 3332.

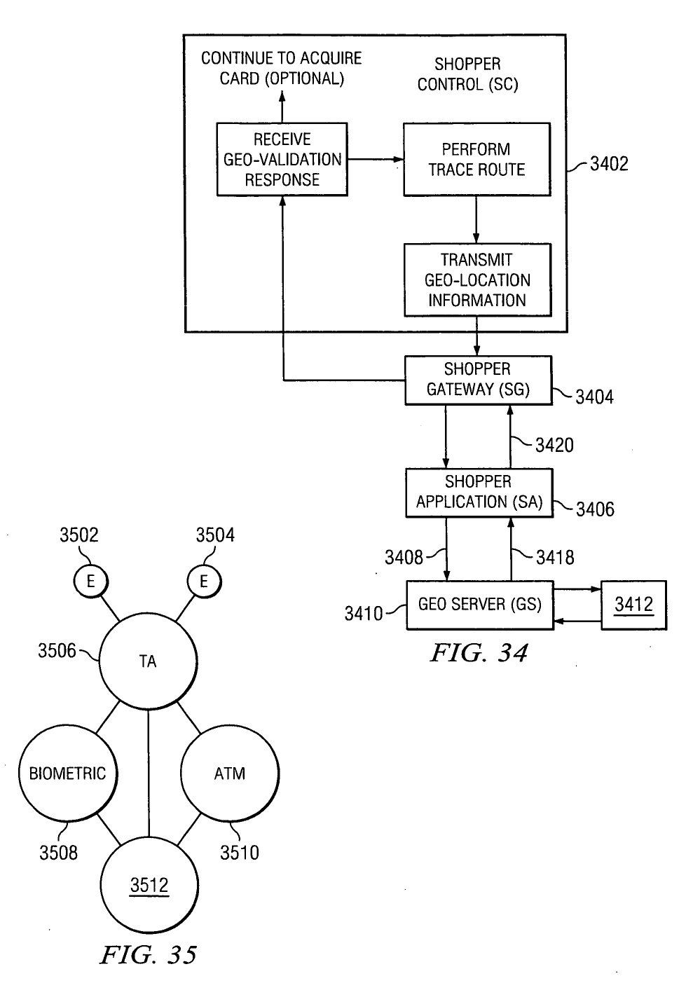

Referring out to FIG. 34, there is more fully described the geo location process within the authentication process such that a location of an authenticating device may be confirmed with the respect to the transaction manager. Initially, shopper control 3402 initiates the geo location process by performing a trace route to the location of the transaction manager. This enables the determining hops, the average latency, and the name information hop. The shopper controller 3402 will transmit the required information to the shopper gateway 3404. The shopper gateway builds a proprietary message and transmits this information to the shopper application 3406. The shopper application 3406 will route the message at 3408 to the geo server 3410 for storage of the group path and and begin evaluating each hop of the trace route. The geo server 3410 acquires detailed information about the IP address by interrogating secure data storage 3412 or third party data storage from the geo data base to map the IP address into longitude and latitude for each entry. The geo server 3410 identifies the first good IP address and evaluates the first good IP address and down stream IP address to insure they do not represent an unreasonable risk through the transaction. The geo server 3410 returns to the shopper application 3406 at 3418 an additional trace route location authorization to continue or a denial. The shopper application 3406 will return the message to shopper gateway 3404 at 3420. The shopper gateway 3404 will compose an HTTP response to the shopper controller 3402. The shopper gateway 3404 will evaluate the response and continue to acquire the card or instruct the shopper controller 3402 to execute a new trace route to the provided location.

Referring now to FIG. 35, there is illustrated the manner in which multiple authentication networks may be used to authenticate two end points. FIG. 35 illustrates end point 3502 which could be associated with any particular consumer or merchant, and end point 3504 which could be associated with any particular consumer or merchant or other type of authenticated entity. Each of the end points 3502 and 3504 are in communication with a transaction authority 3506. The communication occurs over an open network such as the Internet. Transaction authority 3506 may utilize both a biometric network 3508 and the ATM network 3510 for authentication. The transaction authority 3506 may authenticate either of the end points 3202 and 3504 through the ATM network 3510 using the card number and the associated PIN provided within the ATM network 3510. In this way, the authentication processes provided by the ATM network 3510 may be extended out to a number of end points 3502 and 3504 within the Internet through the transaction authority 3506. This provides a level three authentication.

A level three authorization may also be provided by the biometric network 3508. In this network, some type of biometric feedback is provided such as a voice print, fingerprint, or any of the other biometric data collection processes described herein may be used to authenticate either of points 3502 and 3504 through the transaction authority 3506. Like with the ATM network 3510, the authentication processes provided by the biometric network 3508 may be extended outward two end point on the Internet through the transaction authority 3506.

A level four authorization may be achieved by using a combination of the authentication processes within the biometric network 3508 and the ATM network 3510 through a processing entity 3512. The processing entity 3512 extends both the authentication processes of the ATM network 3510 and the biometric network 3508 through the transaction authority 3506 to each of the end nodes 3502 and 3504. The combined authentication process of both networks provides the level four authorization as established by the EAP and recognized by organizations like Liberty Alliance.

Embodiments of the present invention enable transactions over non-secure network when the user presents any one of these user credentials, (a) PIN, (b) Debit Card and PIN, (c) biometric, (d) biometric and PIN, (e) biometric and Debit Card and PIN, (f) PIN and search code (e.g. account number, phone number, drivers license), (g) search code, (h) biometric and search code. In other words a transaction over a non-secure network can be performed using any permutation or mutation or combination of a PIN, DEBIT Card (ATM card, credit card, gift card, ECT.), biometric, or search code.

When authentication of a consumer has been completed over the non-secure network, the underlying financial or non-financial transaction can be considered non-reputable and said authentication is recognized under one or more of the embodiments as an electronic signature and in compliance with e-sign law. Furthermore, subsequent transactions, performed by the consumer as part of the same or related transactions (e.g. payment transaction), may retain the all of benefits afforded in the authentication transaction.

Furthermore, the user credentials can be used to authenticate the consumer's identity and enable them to perform various financial and non-financial transactions. Also the user credentials can be used to authenticate ACH information provided by third parties (e.g. merchants and other financial institutions or service providers), or to securely obtain ACH information (e.g. routing numbers, account numbers, available and reserve balance amounts).

Embodiments of the invention also use user credentials to authenticate and authorize:

To obtain verification of the users account and balance information;

To transact ACH, perform wire transfers from one DDA to another party's account;

To authorize deductions or deposits for the users DDA by a 3^{rd} party;

To authorize contract obligations, financial and non-financial (e.g. recurring payments and subscription contracts);

To authorize access to a wallet or other data store or 3^{rd} party service that may possess identity, private or other data about the consumer to another party or to the consumer himself;

To access online accounts and systems (e.g. online banking, registration enrollment services);

To authorize use and access for payment to a wallet or other payment service;

To authorize use and access to retrieve medical, personal and other secret or private data; and

To authorize delivery of personal, medical or financial data to a 3^{rd} party;

It will be appreciated by those skilled in the art having the benefit of this disclosure that this invention provides a secure authentication system and method It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A system for authentication over an open network, comprising:
at least one endpoint on the open network;
an transaction authority in communication with the at least one endpoint via the open network;
a ATM network accessible by the authentication authority for authenticating the at least one endpoint;
a biometric network accessible by the authentication authority for authenticating the at least one endpoint; and
wherein the transaction authority may extend the authorization capabilities of the ATM network to the at least one endpoint via the open network to provide authentication of the at least one endpoint and further wherein the transaction authority may extend the authorization capabilities of the biometric network to the at least one endpoint via the open network to provide authentication of the at least one endpoint.

2. The system of claim 1, further including a processing entity for combining the authentication capabilities the ATM network and the biometric network such that the authorization capabilities of both the ATM network and the biometric network are extended to the at least one endpoint via the open network to provide authentication of the at least one endpoint.

3. The system of claim 1, further including a program module associate with the at least one endpoint, said program module enabling an associated endpoint to authenticate upstream and downstream endpoints.

4. The system of claim 3, wherein the transaction authority further determines a location of the at least one endpoint by generating a location request to the program module within the at least one endpoint and determines a validity of a requested transaction based on the determined location.

5. The system of claim 4, wherein the transaction authority determines geographic data of the at least one endpoint and determines a validity of a requested transaction based on the determined geographic data.

6. The system of claim 3, wherein the software module further acquires, responsive to a request from the transaction authority, a digital imprint provided at the at least one endpoint, the digital imprint being received via a user interface.

7. The system of claim 6, wherein the digital imprint provides a non-specific representation of specific data entered at the at least one endpoint such that the specific data may be extracted at the transaction authority into a user credential.

8. The system of claim 6, wherein the digital imprint comprises a digital representation of a user selection of at least one graphic image representing a credential of the user to secure a transaction over the open network.

9. The system of claim 8, wherein the transaction authority distills the digital imprint into the user selections within a security module within the transaction authority.

10. The system of claim 1, wherein the ATM network and the biometric network may further identify an identity of a user presenting user credentials at the at least one endpoint and the transaction authority extends the identification capabilities of the ATM network to the at least one endpoint via the open network to provide identification at the at least one endpoint and further wherein the transaction authority extends the identification capabilities of the biometric network to the at least one endpoint via the open network to provide identification at the at least one endpoint.
